(19) United States
(12) Patent Application Publication
(10) Pub. No.: US 2025/0380281 A1
(43) Pub. Date: Dec. 11, 2025

(54) MULTICAST TRANSMISSIONS IN INACTIVE STATE

(71) Applicant: Apple Inc., Cupertino, CA (US)

(72) Inventors: Fangli Xu, Beijing (CN); Ralf Rossbach, Munich (DE); Chunhai Yao, Beijing (CN); Haijing Hu, Los Gatos, CA (US); Dawei Zhang, Saratoga, CA (US); Yuqin Chen, Beijing (CN); Naveen Kumar R. Palle Venkata, San Diego, CA (US); Pavan Nuggehalli, San Carlos, CA (US)

(73) Assignee: Apple Inc., Cupertino, CA (US)

(21) Appl. No.: 18/877,982

(22) PCT Filed: Jul. 22, 2022
(86) PCT No.: PCT/CN2022/107466

§ 371 Date: Dec. 20, 2024

(51) Int. Cl. H04W 72/30; H04W 76/27

(52) U.S. Cl. CPC H04W 72/30; H04W 76/27

(57) ABSTRACT

The present application relates to devices and components including apparatus, systems, and methods to provide multicast transmissions during an inactive state of a user equipment.

### BACKGROUND

Third Generation Partnership Project (3GPP) networks provide that a base station may transmit signals to one or more user equipments (UEs). For example, the base station may transmit signals directly to a single UE, to a particular group of UEs via multicast, or to all UEs within a range via broadcast. In some of these instances, the UEs may need to be in a connected state to receive the signals transmitted by the base station. For example, UEs are required to be in a connected state to receive signals transmitted via multicast from a UE.

### BRIEF DESCRIPTION OF THE DRAWINGS

FIG. 1 illustrates an example table of aspects and features of release 17 (rel-17) multicast multicast/broadcast service (MBS) and broadcast MBS in accordance with some embodiments.

FIG. 2 illustrates an example signal chart of configuration of broadcast MBS in accordance with some embodiments.

FIG. 3 illustrates an example scheduling chart for broadcast MBS in accordance with some embodiments.

FIG. 4 illustrates an example small data transmission (SDT) mechanism signaling chart in accordance with some embodiments.

FIG. 5 illustrates another example SDT mechanism signaling chart in accordance with some embodiments.

FIG. 6 illustrates another example SDT mechanism signaling chart in accordance with some embodiments.

FIG. 7 illustrates an example MBS broadcast configuration information element in accordance with some embodiments.

FIG. 8 illustrates an example multicast/broadcast service system information block (Six) information element in accordance with some embodiments.

FIG. 9 illustrates an example MBSMulticastConfiguration message in accordance with some embodiments.

FIG. 10 illustrates an example SDT procedure signaling chart in accordance with some embodiments.

FIG. 11 illustrates another example SDT procedure signaling chart in accordance with some embodiments.

FIG. 12 illustrates an example signaling chart related to multicast data reception in accordance with some embodiments.

FIG. 13 illustrates an example signaling chart related to multicast data reception in accordance with some embodiments.

FIG. 14 illustrates a first portion of an example procedure related to multicast transmissions received by a user equipment (UE) while in the inactive state in accordance with some embodiments.

FIG. 15 illustrates a second portion of the example procedure of FIG. 14 in accordance with some embodiments.

FIG. 16 illustrates an example procedure related to multicast transmissions in accordance with some embodiments.

FIG. 17 illustrates an example procedure related to multicast transmissions in accordance with some embodiments.

FIG. 18 illustrates an example UE in accordance with some embodiments.

FIG. 19 illustrates an example next generation nodeB (gNB) in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

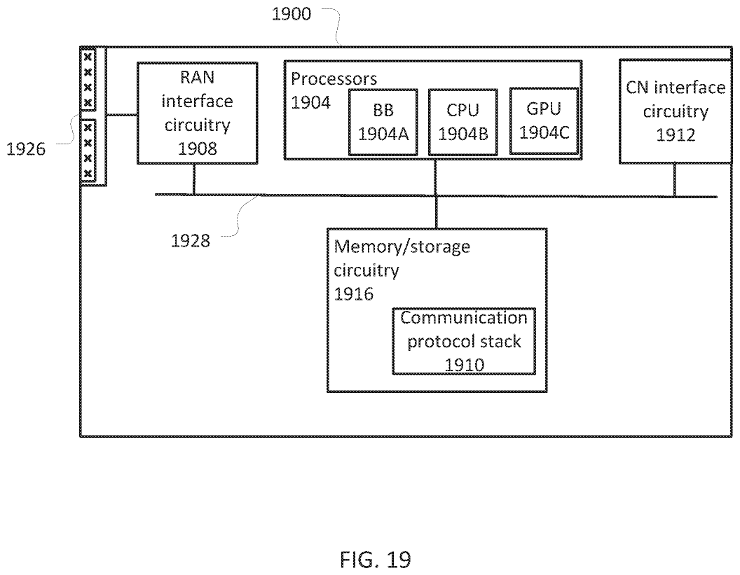

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like. In embodiments, the term “network element” may refer to base station, a nodeB, an evolved nodeB (eNB), and/or a next generation (gNB) (such as the gNB 1900 (FIG. 19)).

The term “information element” refers to a structural element containing one or more fields. The term “field” refers to individual contents of an information element, or a data element that contains content. An information element may include one or more additional information elements.

The disclosure refers to the states of the “connected state,” the “inactive state,” and the “idle state.” These states are well known in the art and should be interpreted as known in the art. For example, each of the “connected state,” the “inactive state,” and the “idle state” may each present at least some different features from the other states and/or may present different connections from the other states.

In legacy Third Generation Partnership Project (3GPP) networks, user equipment (UE) can operate in connected states and inactive states, among other states. When operating in connected state, the UE may maintain a connection with a network element, such as a base station. Maintaining this connection requires power, which can drain the charge of the UE. Maintaining this connection when not required can result in the charge of the UE being drained. Accordingly, the UE may be transitioned to an inactive state where the connection with the network element is released. The UE may utilize less power in the inactive state than the connected state of the UE, which may result in the charge being drained from the UE at a slower rate when in the inactive state than when in the connected state. Accordingly, there can be an advantage to transitioning to the inactive state when possible.

Further in legacy 3GPP networks, a network element can communicate with multiple UEs at once. For example, the network element can transmit signals to all UEs within a transmission area of the network element through broadcast signaling, and/or can transmit signals to a particular group of UEs through multicast signaling. However, multicast signaling is only supported in connected mode of the UE in legacy systems. Accordingly, multicast signaling cannot occur when the UE is in an inactive state is legacy networks. It could be beneficial to allow multicast signaling to occur while the UE is in an inactive state to save power while allowing multicast signaling. Approaches herein can support multicast signaling in an inactive state of the UE and can define configurations to support multicast signaling with the UE being in an inactive state.

### MBS Enhancement

### Justification

To enable resource-efficient delivery of multicast/broadcast services, third generation partnership project (3GPP) has developed new radio (NR) broadcast/multicast in release 17 (Rel-17) according to the work item description (WID) in RP-201038, aiming to enable general multicast/broadcast service (MBS) services over fifth generation system (5GS). The use cases identified that could benefit from this feature include public safety and mission critical, vehicle to everything (V2X) applications, internet protocol television (IPTV), live video, software delivery over wireless and internet of things (IoT) applications, etc. Two delivery modes have been agreed for Rel-17 MBS with delivery mode 1 (only for multicast) capable of addressing higher quality of service (QoS) services and delivery mode 2 (only for broadcast) focusing on lower QoS services. Given that Rel-17 MBS already provide the basic function to support MBS services, the general main goal for release 18 (Rel-18) should be to enable better deployment of MBS, such as improvement of resource efficiency and capacity based on Rel-17 MBS.

In Rel-17, radio access network (RAN) only specifies multicast for user equipments (UEs) in RRC_CONNECTED state, which may not fully fulfil the requirements of, e.g., Mission Critical Services, especially for cells with a large number of UEs according to TR 23.774. Also, to always keep UEs in RRC_CONNECTED state is not power efficient. It is therefore important to support multicast for UEs in RRC_INACTIVE.

The Rel-17 new radio (NR) MBS broadcast solution allows that the UE receives broadcast service in a downlink only manner i.e. performing broadcast reception without a need to access the network beforehand. However, in the typical use case for broadcast, the UE may be required to simultaneously receive broadcast service and unicast service from the network(s) of same or another operator, and some UEs may share the hardware resources between broadcast and unicast. Therefore, the unicast connection might be impacted by the broadcast reception for this kind of UEs. The optimization for such case is not specifically addressed in Rel-17, and should focus on the case of unicast reception in RRC_CONNECTED and broadcast reception from the same or different operators, including emergency and public safety broadcast.

Network sharing is a common practice to reduce network capital expenditure (CAPEX). With RAN sharing deployment, if the same Multicast/Broadcast service is provided by two (or more) operators separately, this service would be recognized as separate temporary mobile group identities (TMGIs) resulting in duplicated point to multipoint (PTM) radio resources consumption in the same cell for transmission of the same content. This justifies resource efficiency improvement in the RAN sharing scenario.

Note that public safety services benefit from the Rel-17 NR MBS functions, as well as from Rel-18 enhancements that follow the above justifications.

### Objective

Objective of system information (SI) or Core part work item (WI) or Testing part WI.

This Work Item is to further enhance the NR Multicast/Broadcast functions based on Rel-17 MBS. The objectives for Rel-18 include specify support of multicast reception by UEs in RRC_INACTIVE state [radio access network group 2 (RAN2), radio access network group 3 (RAN3)], PTM configuration for UEs receiving multicast in RRC_INACTIVE state [RAN2], and study the impact of mobility and state transition for UEs receiving multicast in RRC_INACTIVE (Seamless/lossless mobility is not required) [RAN2, RAN3]. The objectives further include specify Uu signalling enhancements to allow a UE to use shared processing for MBS broadcast and unicast reception, i.e., including UE capability and related assistance information reporting regarding simultaneous unicast reception in RRC_CONNECTED and MBS broadcast reception from the same or different operators [RAN2], and study and, if necessary, specify enhancements to improve the resource efficiency for MBS reception in RAN sharing scenarios [RAN3]. Note: collaboration with system aspects working group 2 (SA2) is expected in due course for the above objectives.

### Multicast MBS and Broadcast MBS

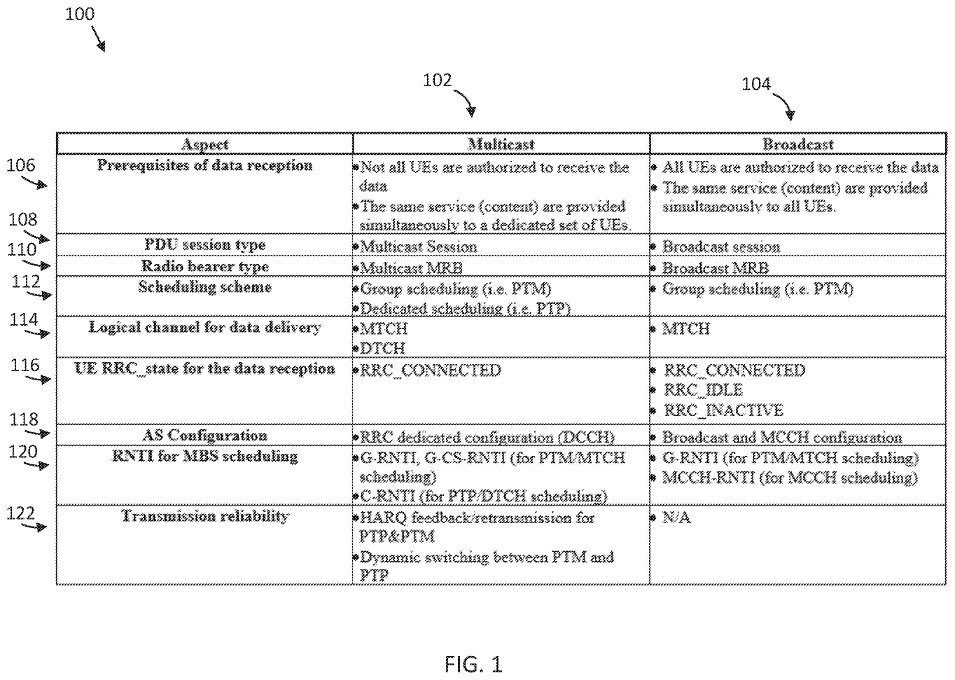

FIG. 1 illustrates an example table 100 of aspects and features of rel-17 multicast MBS and broadcast MBS in accordance with some embodiments. For example, the table 100 illustrates some features that may be related to multicast MBS 102 and broadcast MBS 104. The multicast MBS 102 may correspond to multicast signaling and the broadcast MBS 104 may correspond to broadcast signalling.

As can be seen from the table 100, the multicast MBS 102 and the broadcast MBS 104 have some prerequisites of data reception 106. In particular, for multicast MBS 102, not all UEs are authorized to receive the data. Further, the same service (content) is provided simultaneously to a dedicated set of UEs. For broadcast MBS 104, all UEs are authorized to receive the data. Further, the same service (content) is provided simultaneously to all UEs.

Each of the multicast MBS 102 and the broadcast MBS 104 have packet data unit session types 108. The multicast MBS 102 has a multicast session type. The broadcast MBS 104 has a broadcast session type.

Each of the multicast MBS 102 and the broadcast MBS 104 utilize a radio bearer type 110. The multicast MBS 102 utilizes multicast MRB. The broadcast MBS 104 utilizes broadcast MRB.

The multicast MBS 102 and the broadcast MBS 104 have one or more scheduling schemes 112. The multicast MBS 102 makes use of a group scheduling scheme (i.e., PTM) or a dedicated scheduling scheme (i.e., PTP). The broadcast MBS 104 makes use of a group scheduling scheme (i.e., PTM).

Each of the multicast MBS 102 and the broadcast MBS 104 utilizes one or more logical channels for data delivery 114. The multicast MBS 102 utilizes MTCH or DTCH. The broadcast MBS 104 utilizes MTCH.

A UE has particular RRC states for data reception 116 for each of the multicast MBS 102 and the broadcast MBS 104. The multicast MBS 102 is implemented in the RRC_CONNECTED state. The broadcast MBS 104 can be implemented in the RRC_CONNECTED state, the RRC_IDLE state, or the RRC_INACTIVE state.

An access stratum configuration 118 is defined for each of the multicast MBS 102 and the broadcast MBS. For the multicast MBS 102, the AS configuration is RRC dedication configuration (DCCH). For the broadcast MBS 104, the AS configuration is broadcast and MCCH configuration.

Each of the multicast MBS 102 and the broadcast MBS 104 have defined RNTI for MBS scheduling 120. The multicast MBS 102 utilizes global system for mobile communications enhanced data for global evolution radio access network radio network temporary identifier (G-RNTI) or global system for mobile communications enhanced data for global evolution configured scheduling (G-CS-RNTI) for PTM/MTCH scheduling. Further, the multicast MBS 102 utilizes cell radio network temporary identifier (C-RNTI) for PTP/DTCH scheduling. The broadcast MBS 104 utilizes G-RNTI for PTM/MTCH scheduling. Further, the broadcast MBS 104 utilizes multimedia broadcast multicast service point-to-multipoint control channel radio network temporary identifier (MCCH-RNTI) for MCCH scheduling.

The multicast MBS 102 implements transmission reliability approaches 122. For example, the multicast MBS 102 implements HARQ feedback/retransmission for PTP and PTM. Further, the multicast MBS 102 implements dynamic switching between PTM and PTP. Different aspects and/or features for multicast MBS 102 and/or broadcast MBS 104 may be presented by the approaches described herein.

### R17 MBS: Configuration of Broadcast MBS

2-step MBS broadcast configuration acquisition for UE in RRC_CONNECTED/IDLE/INACTIVE state can be implemented. The UE receives the MBS configuration for broadcast session via multicast/broadcast service control channel (MCCH). The UE receives the MCCH according to the MCCH configuration which is provided in multicast/broadcast service system information block (SIBx).

The MBS broadcast configuration in MCCH. The MCCH provides the list of all broadcast services with ongoing sessions transmitted on multimedia broadcast multicast service point-to-multipoint traffic channel(s) (MTCH(s)) and the associated information for broadcast session (e.g. MBS session identifier (ID), G-RNTI and scheduling info, neighbor cell info for MTCH).

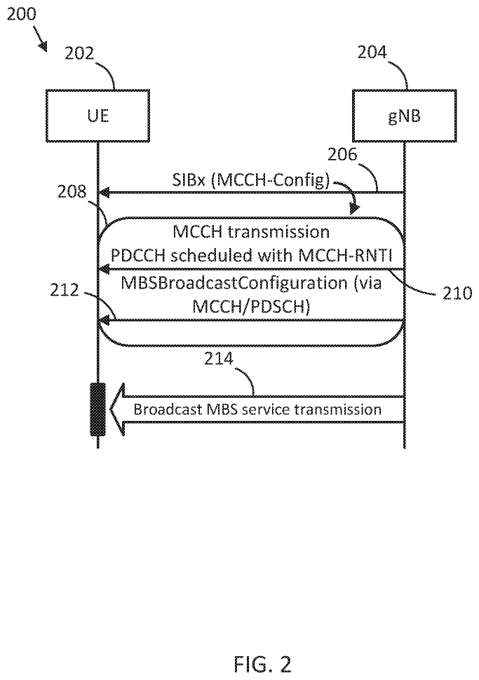

FIG. 2 illustrates an example signal chart 200 of configuration of broadcast MBS in accordance with some embodiments. The procedure illustrated by the signal chart 200 can configure a broadcast MBS between a UE 202 and a network element 204. The network element may be a base station, such as a nodeB, an evolved NodeB (eNB), or a next generation NodeB (gNB). In the embodiment illustrated, the network element 204 comprises a gNB.

The UE 202 is interested in MBS broadcast in the illustrated embodiment. The network element 204 transmits an SIBx message 206 to the UE 202. The SIBx message 206 is a MCCH-Config message. The SIBx message 206 includes mcch-RepetitionPeriodAndOffset-r17, mcch-WindowStartSlot-r17, mcch-WindowDuration-r17, and mch-ModificationPeriod-r17 information elements.

The SIBx message 206 initiates a MCCH transmission procedure 208. During the MCCH transmission procedure 208, the network element 204 transmits a PDCCH scheduled with MCCH-RNTI message 210 and a MBSBroadcastConfiguration message 212. The MBSBroadcastConfiguration message 212 is transmitted via MCCH and/or PDSCH. The MBSBroadcastConfiguration message 212 includes mbs-SessionInfoList-r17, mbs-NeighbourCellList-r17, and drx-ConfigPTM-List-r17 information elements. The mbs-SessionInfoList-r17 information element includes mbs-SessionId-r17, g-RNTI-r17, mrb-ListBroadcast-r17, mtch-SchedulingInfo-r17, and mtch-NeighbourCell-r17 information elements. The mbs-NeighbourCellList-r17 information element includes physCellId-r17, and carrierFreq-r17 information elements. The drx-ConfigPTM-List-r17 information element includes drx-onDurationTimerPTM-r17, drx-InactivityTimerPTM-r17, drx-HARQ-RTT-TimerDL-PTM-r17, drx-RetransmissionTimerDL-PTM-r17, drx-LongCycleStartOffsetPTM-r17, and drx-SlotOffsetPTM-r17 information elements.

Based on the MCCH transmission procedure 208, the UE 202 establishes the broadcast MRB. For example, the UE 202 establishes the service data adaptation protocol (SDAP) entity, establishes the packet data convergence protocol (PDCP) entity, and establishes the RLC entity. The UE 202 further applies the physical layer (PHY) configuration and informs upper layer about the temporary mobile group identity (TMGI).

The network element 204 provides broadcast MBS service transmission 214 to the UE 202. The broadcast MBS service transmission can be provided on the broadcast MRB established by the UE 202.

### R17 MBS: MCCH Transmission of Broadcast MBS

MCCH scheduling. The MCCH information is transmitted periodically, using the configurable repetition period and within a transmission window. The MCCH transmission is scheduled via the physical downlink control channel (PDCCH) addressed to MCCH-RNTI in mcch-Searchspace.

MCCH information validity and the notification of changes. MCCH modification period. Within a period, the same MCCH information may be transmitted a number of times based on a repetition period configuration. The change of MCCH information only occurs at each modification period boundary.

MCCH change notification. A notification mechanism is used to announce the change of MCCH information due to broadcast session start/stop/change or neighbouring cell information modification. Notification design: 2-bit bitmap (i.e. XY) in the MCCH scheduling downlink control information (DCI). X-bit to indicate the start of the new MBS service, Y-bit to indicate other cause.

UE operation: when the UE receives the change notification, it acquires the updated MCCH in the same MCCH modification period where the notification is sent. The UE applies the previously acquired MCCH information until the UE acquires the new MCCH information.

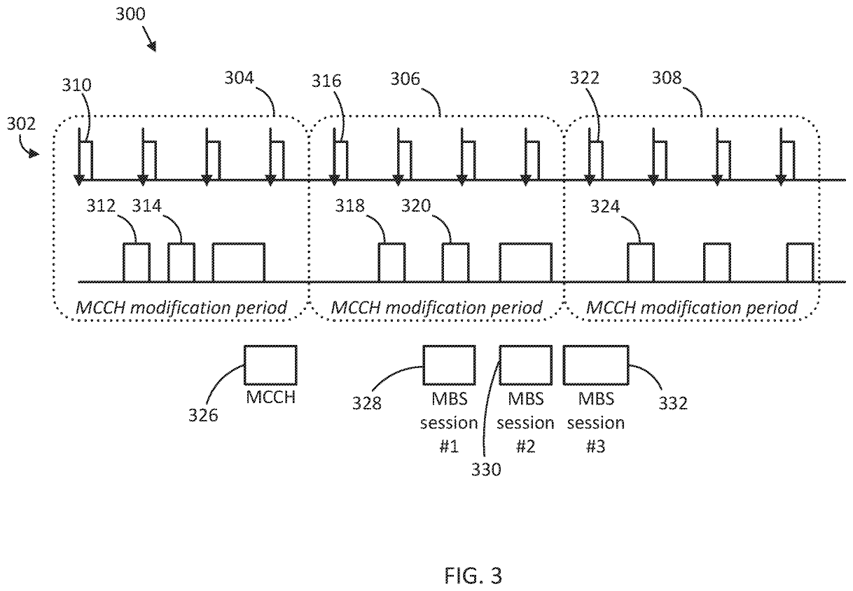

FIG. 3 illustrates an example scheduling chart 300 for broadcast MBS in accordance with some embodiments. For example, the scheduling chart 300 illustrates the scheduling of broadcast MBS transmissions.

An MCCH configuration is provided by SIBx. In the scheduling chart 300, a plurality of SIBx 302 is illustrated. The SIBx 302 can provide MCCH configuration. In particular, the SIBx 302 can define times where MBS configuration can be modified.

The scheduling chart 300 illustrates a first MCCH modification period 304, a second MCCH modification period 306, and a third MCCH modification period 308. A portion of the SIBx 302 within a modification period can define times where MCCH can be transmitted within the modification period to define MBS configuration. In particular, a first block 310 of the SIBx 302 can schedule a first block 312 and a second block 314 within the first MCCH modification period 304 where MCCH transmissions can be received. A second block 316 of the SIBx 302 can schedule a third block 318 and a fourth block 320 within the second MCCH modification period 306 where MCCH transmissions can be received. A third block 322 of the SIBx 302 can schedule a fifth block 324 within the third MCCH modification period 308 where MCCH transmissions can be received.

The network (such as via a network element) may provide an MCCH message 326 to the UE. The MCCH message 326 can schedule broadcast MBS transmissions. For example, the MCCH message 326 can schedule a first MBS session 328, a second MBS session 330, and a third MBS session 332.

### R17 SDT Mechanism

R17 small data transmission (SDT). For the uplink (UL) data arrival of some radio bearers (RBs) (i.e. small data transmission radio bearer (SDT-RB)), based on network (NW) configuration, the INACTIVE UE can trigger the SDT procedure.

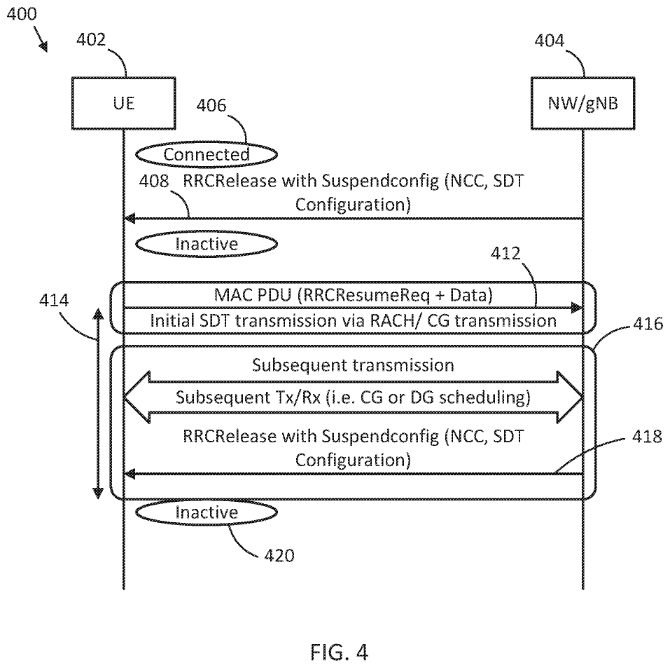

FIG. 4 illustrates an example SDT mechanism signaling chart 400 in accordance with some embodiments. The SDT mechanism signaling chart 400 illustrates example SDT configuration with example SDT transmission.

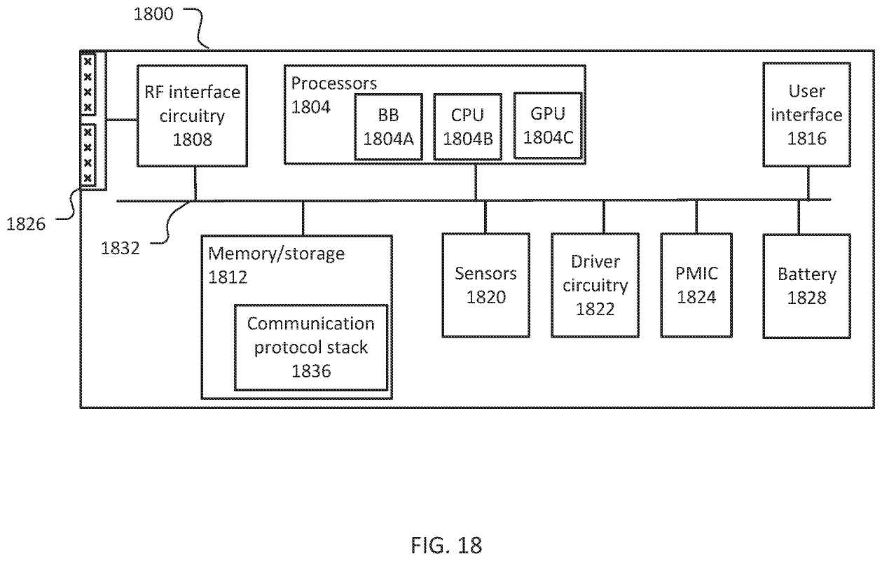

The signaling chart 400 illustrates transmissions between a UE 402 and a network element 404. The UE 402 may include one or more of the features of the UE 1800 (FIG. 18). The network element 404 may include one or more of the features of the gNB 1900 (FIG. 19). The UE 402 may be in a connected state at the beginning of the signaling chart 400 as indicated by connected 406, where the UE 402 may maintain a connection with the network element 404. The network element 404 may transmit an RRCRelease with Suspendconfig message 408. The RRCRelease with Suspendconfig message 408 may include next hop chaining count (NCC) and SDT configuration. The UE 402 can configure for SDT based on the SDT configuration received in the RRCRelease with Suspendconfig message 408. Further, the UE 402 may transition to an inactive state based on the RRCRelease with Suspendconfig message 408 as indicated by inactive 410. For example, the UE 402 may release a connection with the network element 404 to transition to the inactive state based on the RRCRelease with Suspendconfig message 408.

While in the inactive state, the UE 402 may transmit a medium access (MAC) protocol data unit (PDU) message 412 to the network element 404. The UE 402 may transmit the MAC PDU message 412 based on uplink (UL) data arrival and SDT criteria being fulfilled. For example, the UE 402 may have UL data arrive for providing to the network element 404. The UE 402 may be configured with SDT criteria that defines when an SDT transmission procedure can be performed. When the UL data has arrived and the SDT criteria is fulfilled, the UE 402 may resume an SDT-data radio bearer. The MAC PDU message 412 may include an RRCResumeReq information element and data (such as the UL data or some portion thereof). The RRCResumeReq information element may comprise a request from the UE 402 to establish an RRC connection between the UE 402 and the network element 404. The MAC PDU message 412 may be an initial SDT transmission via RACH/configured grant (CG) transmission. The MAC PDU message 412 may initiate an SDT period 414.

One or more subsequent transmissions 416 may be exchanged between the UE 402 and the network element 404 following the MAC PDU message 412. For example, the subsequent transmissions 416 may include one or more UL messages and/or one or more downlink (DL) messages exchanged between the UE 402 and the network element 404. The subsequent transmissions 416 may be scheduled via configured grant (CG) and/or dynamic grant (DG) scheduling. To complete the subsequent transmissions 416, the network element 404 may transmit an RRCRelease with Suspendconfig message 418 to the UE 402. The RRCRelease with Suspendconfig message 418 may include one or more of the features of the RRCRelease with Suspendconfig message 408. The UE 402 and the network element 404 may terminate the SDT period 414 in response to the RRCRelease with Suspendconfig message 418. The UE 402 may remain in the inactive state, as indicated by inactive 420.

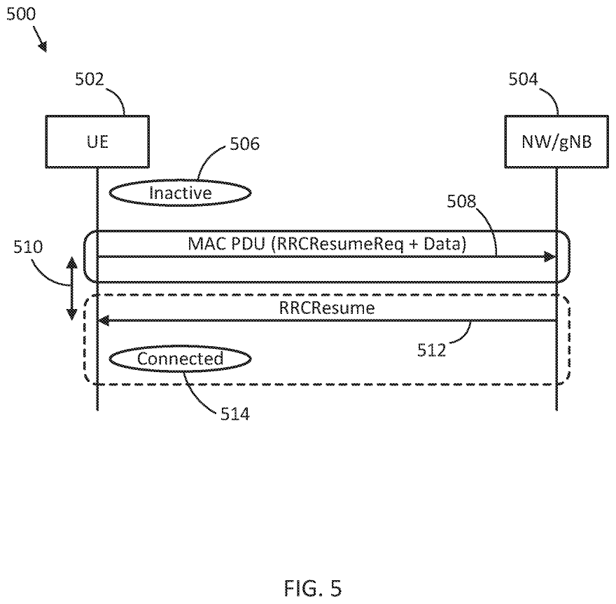

FIG. 5 illustrates another example SDT mechanism signaling chart 500 in accordance with some embodiments. The SDT mechanism signaling chart 500 illustrates example SDT configuration with example SDT transmission.

The signaling chart 500 illustrates transmissions between a UE 502 and a network element 504. The UE 502 may include one or more of the features of the UE 1800 (FIG. 18). The network element 504 may include one or more of the features of the gNB 1900 (FIG. 19). The UE 502 may be in an inactive state at the beginning of the signaling chart, as indicated by inactive 506. During the inactive state, the UE 502 may not have a connection (such as an RRC connection) with the network element 504. In some embodiments, the UE 502 may have been previously configured with an SDT configuration to support SDT transmission.

The UE 502 may transmit a MAC PDU message 508 to the network element 504. The UE 502 may transmit the MAC PDU message 508 based on arrival of UL data for providing to the network element 504. The MAC PDU message 508 may include an RRCResumeReq information element and data (such as the UL data or some portion thereof). The RRCResumeReq information element may comprise a request to establish an RRC connection between the UE 502 and the network element 504. The transmission of the MAC PDU message 508 may initiate an SDT period 510 for SDT transmissions.

In response to receiving the MAC PDU message 508, the network element 504 may determine to establish an RRC connection between the UE 502 and the network element 504. The network element 504 may transmit an RRCResume message 512 to the UE 502. The RRCResume message 512 may indicate an RRC connection is to be established between the UE 502 and the network element 504, where the RRCResume message 512 may include information for establishing the connection. The RRCResume message 512 may terminate the SDT period 510.

The UE 502 may transition to a connected state with the network element 504 based on the reception of the RRCResume message 512, as indicated by connected 514. While in the connected state, the UE 502 may maintain a connection (such as an RRC connection) with the network element 504.

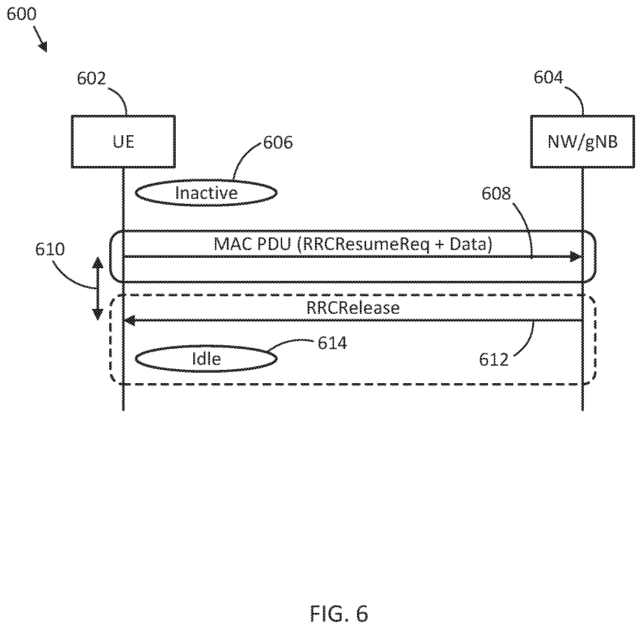

FIG. 6 illustrates another example SDT mechanism signaling chart 600 in accordance with some embodiments. The SDT mechanism signaling chart 600 illustrates example SDT configuration with example SDT transmission.

The signaling chart 600 illustrates transmissions between a UE 602 and a network element 604. The UE 602 may include one or more of the features of the UE 1800 (FIG. 18). The network element 604 may include one or more of the features of the gNB 1900 (FIG. 19). The UE 602 may be in an inactive state at the beginning of the signaling chart, as indicated by inactive 606. During the inactive state, the UE 602 may not have a connection (such as an RRC connection) with the network element 604. In some embodiments, the UE 602 may have been previously configured with an SDT configuration to support SDT transmission.

The UE 602 may transmit a MAC PDU message 608 to the network element 604. The UE 602 may transmit the MAC PDU message 608 based on arrival of UL data for providing to the network element 604. The MAC PDU message 608 may include an RRCResumeReq information element and data (such as the UL data or some portion thereof). The RRCResumeReq information element may comprise a request to establish an RRC connection between the UE 602 and the network element 604. The transmission of the MAC PDU message 608 may initiate an SDT period 610 for SDT transmissions.

In response to receiving the MAC PDU message 608, the network element 604 may determine that the UE 602 can be transitioned to an idle state. The network element 604 may transmit an RRCRelease message 612 to the UE 602 based on the determination to transition the UE 602 to the idle state. The RRCRelease message 612 may terminate the SDT period 610. The RRCRelease message 612 may indicate that the UE 602 is to transition to the idle state. The UE 602 may transition to the idle state based on the RRCRelease message 612, as indicated by idle 614.

### Issue Statement

In R17, NW can provide the high reliability multicast transmission to the CONNECTED UE via the following methods. Multicast/broadcast service radio bearer (MRB) bearer can be configured via point-to-multipoint (PTM) and/or point-to-point (PTP) link, and the configuration is via radio resource control (RRC) dedicated signaling.

For PTP link, the transmission is via dedicated traffic channel (DTCH) channel. The radio link control (RLC) layer can be configured with radio link control acknowledged mode (RLC-AM) or unacknowledged mode (UM) mode. The transmission is almost same as unicast transmission.

For PTM link, the transmission is via MTCH channel. RLC layer is only configured via RLC-UM mode. For the hybrid automatic repeat request (HARQ) transmission, NW can configure 3 feedback modes: 1) no feedback; 2) acknowledgement/negative acknowledgement (A/N) feedback; 3) negative acknowledgement (NACK) only feedback.

NW can provide the high-reliability scheduling for the multicast MBS transmission. NW can select PTP or PTM link for the transmission based on the transmission quality or radio quality. HARQ retransmission can be based on HARQ feedback via PTP or PTM feedback channel (e.g. physical uplink control channel (PUCCH)). PTM scheduling can be based on UE specific radio quality reporting (e.g. channel state information (CSI) report) in the PTM UE group.

In release 18 (R18), if multicast transmission is supported in the INACTIVE state, since the DTCH and feedback channel is not supported in INACTIVE state, the following issues should be considered. Issue 1: how to support the MTCH transmission in INACTIVE state. Issue 2: how to support the DTCH transmission in INACTIVE state. Issue 3: how to provide the high-reliability scheduling for the multicast MBS transmission in INACTIVE state.

### Approach 1: The Transmission Scheme Via MTCH

Approach: Extend the current broadcast MBS scheme to cover multicast MBS transmission in INACTIVE state. For example, a legacy broadcast MBS scheme may provide for broadcast MBS transmissions while a UE is in the inactive state. An information element may provide a configuration for the UE in the inactive state to receive and/or transmit broadcast MBS transmissions. Based on the information element, a UE may be configured to receive and/or transmit broadcast MBS transmissions. This approach of providing a configuration in an information element for configuring a UE to receive and/or transmit broadcast MBS transmissions could be extended to configure the UE to receive and/or transmit multicast MBS transmissions.

Configuration: Extend the current SIBx/MCCH/MTCH configuration to cover multicast transmission. For example, the legacy scheme of configuring broadcast transmissions via SIBx, MCCH, and MTCH transmissions can be extended to configure a UE for multicast transmissions. For example, the MCCH configuration discussed in relation to FIG. 3 may be extended to provide for multicast MTCH configuration for an inactive UE.

Option 1.1: Extend current MCCH configuration to provide both broadcast and multicast MBS MTCH configuration. One MCCH configuration is used to include both the broadcast and multicast MBS MTCH configuration. For example, a legacy MCCH configuration information element utilized for configuring broadcast MTCH configuration could be extended to be utilized for configuring multicast MTCH configuration. In some embodiments, a bit may be included in the MCCH configuration information element to indicate whether an MTCH configuration is to be utilized for broadcast or multicast transmissions.

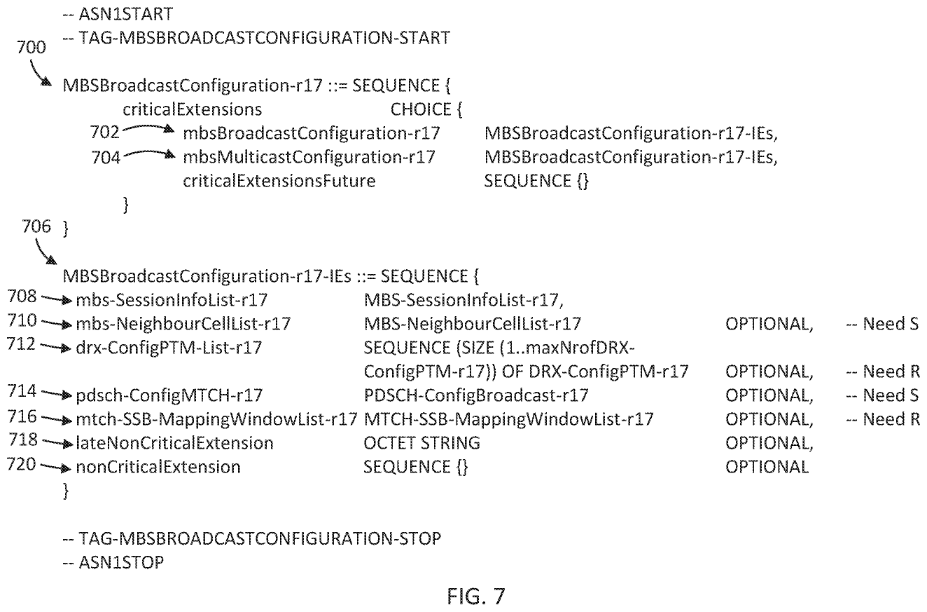

FIG. 7 illustrates an example MBS broadcast configuration information element 700 in accordance with some embodiments. The MBS broadcast configuration information element 700 illustrates an information element that can be transmitted from a network element (such as the gNB 1900 (FIG. 19)) to a UE (such as the UE 1800 (FIG. 18)) to configure a UE for transmissions. The MBS broadcast configuration information element 700 can be transmitted in an MCCH message (such as the MCCH message 326 (FIG. 3)).

The MBS broadcast configuration information element 700 may include an mbsBroadcastConfiguration element 702. The mbsBroadcastConfiguration element 702 may be utilized for configuring a UE for broadcast MBS MTCH configuration. For example, the mbsBroadcastConfiguration element 702 may configure the UE for broadcast transmissions when the UE is in the inactive state. The mbsBroadcastConfiguration element 702 may include one or more features of mbsBroadcastConfiguration elements included in legacy MBS broadcast configuration information elements, such as MBS broadcast configuration information elements of R17.

The MBS broadcast configuration information element 700 may further include an mbsMulticastConfiguration element 704. The mbsMulticastConfiguration element 704 may be utilized for configuring a UE for multicast MBS MTCH configuration. For example, the mbsMulticastConfiguration element 704 may configure the UE for multicast transmissions when the UE is in the inactive state. In the illustrated embodiment, the configuration of the mbsMulticastConfiguration element 704 may be the same configuration as the mbsBroadcastConfiguration element 702. In other embodiments, the configuration of the mbsMulticastConfiguration element 704 may be different from the configuration of the mbsBroadcastConfiguration element 702.

FIG. 7 further illustrates information elements 706 that may be utilized to define the configuration for the mbsBroadcastConfiguration element 702 and/or the mbsMulticastConfiguration element 704 in accordance with some embodiments. In the illustrated embodiments, the information elements 706 may define the configuration for both the mbsBroadcastConfiguration element 702 and the mbsMulticastConfiguration element 704.

The information elements 706 may include an mbs-SessionInfoList 708, an mbs-NeighbourCellList 710, a drx-ConfigPTM-List 712, a pdsch-ConfigMTCH 714, a mtch-SSB-MappingWindowList 716, a lateNonCriticalExtension 718, and/or a nonCritical extension 720. The information elements 706 may define a configuration for a UE. When the information elements 706 are utilized in the mbsMulticastConfiguration element 704, the information elements 706 may define a configuration for a UE for multicast configurations when the UE is in an inactive state.

Option 1.2: Introduce a new MCCH configuration especially for the multicast MTCH configuration provision. Add a new multicast MCCH configuration in the SIBx, in parallel with the release 17 (R17) MCCH configuration. For example, a new MCCH configuration may be indicated in an SIBx, such as the SIBx 302 (FIG. 3). In particular, the MCCH configuration may be indicated in a block of the SIBx, such as the blocks shown in relation to the SIBx 302.

In the new multicast MCCH configuration, all the MBS sessions and MTCH configurations may be for multicast MBS. The MBS MCCH change notification for broadcast and multicast MCCH may be individual procedure. The message carried via the MCCH channel can be called as MBSMulticastConfiguration, which is similar as the MBSBroadcastConfiguration configuration.

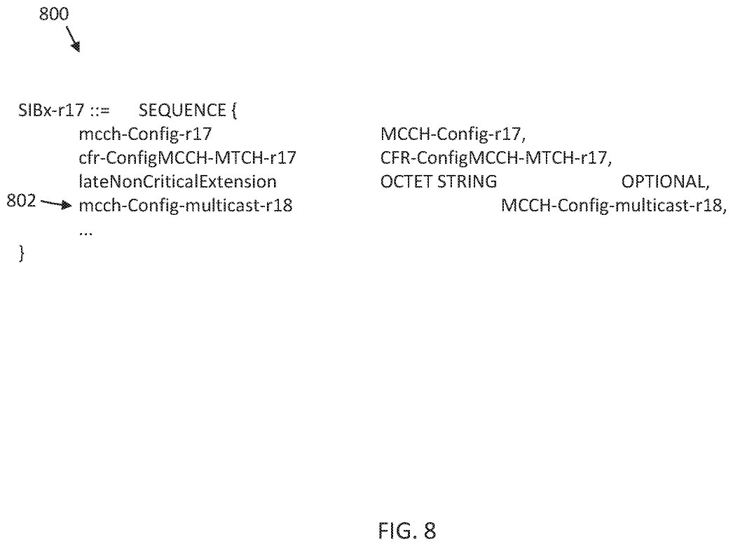

FIG. 8 illustrates an example SIBx information element 800 in accordance with some embodiments. The SIBx information element 800 may be included in an SIBx transmission, such as any of the SIBx blocks related to the SIBx 302 (FIG. 3).

The SIBx information element 800 may include a multicast MCCH configuration element 802. The MCCH configuration element 802 may be utilized to configure the MCCH for multicast configuration. For example, the MCCH configuration element 802 may be utilized for configuring the MCCH for one or more MBS multicast configuration messages.

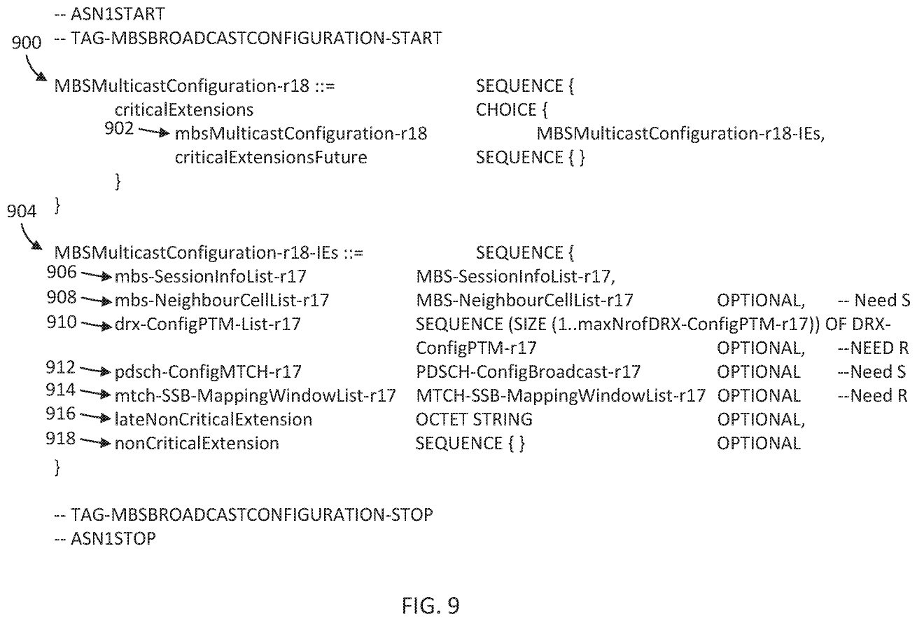

FIG. 9 illustrates an example MBSMulticastConfiguration message 900 in accordance with some embodiments. The MBSMulticastConfiguration message 900 may be utilized for configuring a UE for multicast transmissions when the UE is in the inactive state. The MBSMulticastConfiguration message 900 may be transmitted in an MCCH message, such as the MCCH message 326 (FIG. 3).

The MBSMulticastConfiguration message 900 includes a mbsMulticastConfiguration element 902. The mbsMulticastConfiguration element 902 may be utilized for defining a configuration for a UE for multicast transmissions when the UE is in the inactive state.

The mbsMulticastConfiguration element 902 may include one or more information elements. FIG. 9 further illustrates example information elements 904 that may be included in the mbsMulticastConfiguration element 902. The information elements 904 may include an mbs-SessionInfoList 906, an mbs-NeighbourCellList 908, a drx-ConfigPTM-List 910, a pdsch-ConfigMTCH 912, a mtch-SSB-MappingWindowList 914, a lateNonCriticalExtension 916, and/or a nonCriticalExtension 918. The information elements 904 may define a configuration for a UE for multicast transmissions when the UE is in the inactive state.

Alternatively, NW can provide the configuration SIBx/MCCH/MTCH via the dedicated RRC signaling to the UE. For example, rather than providing the MBSMulticastConfiguration message 900 via an MCCH message, the NW (via a network element) may provide the MBSMulticastConfiguration message 900 via RRC signaling to the UE. The MBSMulticastConfiguration message 900 provided from the NW to the UE via the RRC signaling may configure the UE for multicast transmissions when the UE is in the inactive state.

UE behavior. UE follows the same method of broadcast MBS configuration acquisition to acquire the multicast configuration for a joint activated MBS session. UE receives the multicast via MTCH in the same way as the broadcast MBS reception, i.e. supports the PTM transmission without feedback, follow the PTM discontinuous reception (DRX) without feedback scheme, the layer 2 (L2) variable setting follow the broadcast scheme.

### Approach 2: The Transmission Scheme Via DTCH

Approach: using the SDT mechanism to support the multicast transmission via DTCH in INACTIVE state. For example, a UE may be configured for utilizing SDT to support multicast transmission when the UE in in the inactive state. The SDT transmissions may be transmitted via the DTCH.

Configuration. NW configures the multicast transmission reception as one of the SDT trigger conditions via RRCRelease message, optionally including the following configuration: The MBS session which can trigger the SDT procedure for multicast reception in INACTIVE state; The MBS specific SDT configuration, e.g. the multicast specific layer 1 (L1)/L2/layer 3 (L3) configuration, or the SDT specific timer setting. For example, the NW may transmit (via a network element) an RRCRelease message to a UE to configure multicast transmission reception for the UE. In some embodiments, the configuration may have an MBS session trigger an SDT procedure for multicast reception when the UE is in the inactive state. In some embodiments, the configuration may be an MBS specific SDT configuration, which may comprise multicast specific L1, L2, and/or L3 configuration and/or an SDT specific timer setting.

UE behavior. When the SDT specific MBS session is activated, UE triggers the SDT procedure, and inform the NW about the MBS trigger via the following information: Option 1: MBS specific SDT random access channel (RACH) procedure; Option 2: MBS specific resume cause value; and/or Option 3: MBS activation specific L2/L1 information. For example, the NW may provide (such as via a network element) an MBS session activation notification to the UE. Based on receiving the MBS session activation notification, the UE may trigger an SDT procedure by transmitting a multicast specific SDT request to the NW. The multicast specific SDT request may indicate an MBS specific SDT RACH procedure, an MBS specific resume cause value, and/or MBS activation specific L2 and/or L1 information.

For the MBS specific SDT RACH procedure, the UE can select the RACH resource for the MBS-specific SDT RACH configuration. The UE may then trigger the RACH procedure to tell the NW that the MBS trigger is for data reception purposes.

For the MBS specific resume cause value approach. The UE may indicate to the network the cause to trigger the SDT. The cause may be indicated by the resume cause value. The resume cause value may be provided by the UE to the network element in a first RRC message transmitted from the UE to the NW during the SDT procedure.

For the MBS activation specific L2 and/or L1 information approach, the UE may indicate to the NW a special medium access control (MAC) control element (CE) or L 1 physical uplink control channel (PUCCH) for the SDT procedure. The UE may indicate that the special MAC CE or L1 PUCCH is for the SDT procedure for the MBS activation purpose.

NW can keep UE in the SDT procedure for the MBS multicast reception via the DTCH, or switch UE back to CONNECTED. For example, the network may determine whether to maintain the UE in the SDT procedure for the multicast or provide an indication to the UE indicating that the UE should transition to the connected state. The NW may determine whether to maintain the UE in the SDT procedure or indicate to the UE to transition to the connected state based on information received from the UE in the multicast specific SDT request and/or the data to be exchanged.

UE keeps on the MBS reception via the DTCH channel during the SDT procedure. For example, the UE MBS may receive the multicast data via the DTCH while the SDT procedure is proceeding. The SDT procedure may continue until the NW provides an RRCRelease with SuspendCfg message that indicates the SDT procedure is to be terminated or the NW provides an RRCResume message to the UE indicating the UE is to transition into the connected state.

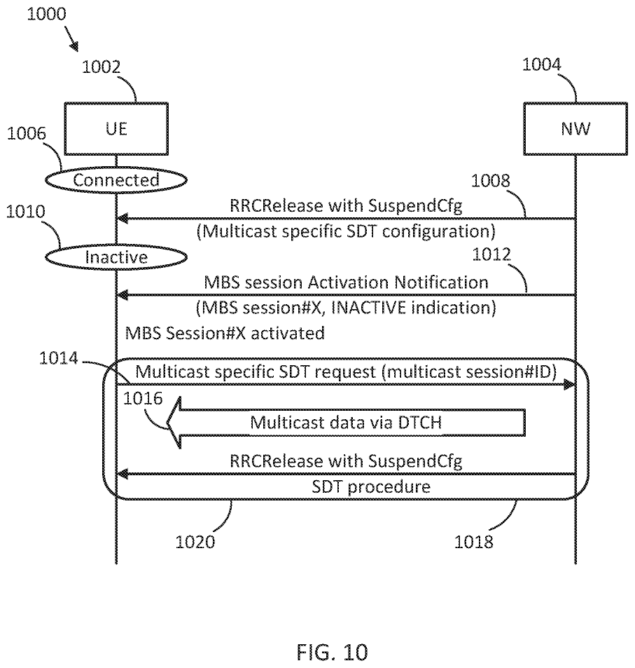

FIG. 10 illustrates an example SDT procedure signaling chart 1000 in accordance with some embodiments. The SDT procedure signaling chart 1000 illustrates example signaling that may be performed related to an SDT procedure.

The signaling chart 1000 illustrates transmissions between a UE 1002 and a network element 1004 that may be transmitted related to an SDT procedure in accordance with some embodiments. The UE 1002 may include one or more of the features of the UE 1800 (FIG. 18). The network element 1004 may include one or more of the features of the gNB 1900 (FIG. 19). The UE 1002 may be in a connected state at the beginning of the signaling chart 1000, as indicated by connected 1006. The UE 1002 may maintain a connection (such as an RRC connection) with the network element 1004 when the UE 1002 is in the connected state.

The network element 1004 may transmit an RRCRelease with SuspendCfg message 1008 to the UE 1002 while the UE 1002 is in the connected state. The RRCRelease with SuspendCfg message 1008 may indicate that the UE 1002 is to transition to an inactive state. The RRCRelease with SuspendCfg message 1008 may indicate a multicast specific SDT configuration. The multicast specific SDT configuration may indicate a configuration for multicast transmissions exchanged during an SDT procedure between the UE 1002 and the network element 1004. In some embodiments, the RRCRelease with SuspendCfg message 1008 may indicate whether the UE 1002 is to implement the MBS specific SDT RACH procedure, the MBS specific resume cause value approach, and/or the MBS activation specific L2 and/or L1 information approach.

The UE 1002 may detect the RRCRelease with SuspendCfg message 1008 received from the network element 1004. The UE 1002 may store the multicast specific SDT configuration in a memory of the UE 1002. The UE 1002 may be configured with the multicast specific SDT configuration for receiving multicast data during an SDT procedure in response to detecting the RRCRelease with SuspendCfg message 1008. The UE 1002 may further determine that the UE 1002 is to transition to the inactive state based on the RRCRelease with SuspendCfg message 1008. Accordingly, the UE 1002 may transition to the inactive state based on the RRCRelease with SuspendCfg message 1008, as indicated by inactive 1010.

The network element 1004 may transmit an MBS session activation notification message 1012 to the UE 1002 while the UE 1002 is in the inactive state. The MBS session activation notification message 1012 may be a special, specific paging message from the NW side. The MBS session activation notification message 1012 may include an indication of which MBS session is being activated in accordance with the MBS session activation notification message 1012. For example, the MBS session activation notification message 1012 may indicate that MBS session #X is being activated in the illustrated embodiment. In some embodiments, the MBS session activation notification message 1012 may further indicate a preferred state for the UE 1002 for reception of the multicast data. In the illustrated embodiment, the MBS session activation notification message 1012 indicates that the inactive state is preferred for the UE 1002 to receive the multicast data. Accordingly, the MBS session activation notification message 1012 may indicate a preference for the UE 1002 to remain in the inactive state to receive the activated MBS session #X in the illustrated.

The UE 1002 may detect the MBS session activation notification message 1012 received from the network element 1004. Based on the detection of the MBS session activation notification message 1012, the UE 1002 may activate the MBS session #X. Further, the UE 1002 may trigger an MBS specific SDT procedure 1018 for receipt of multicast data based on the MBS session activation notification message 1012. The UE may transmit a multicast specific SDT request 1014 to the network element 1004 as part of triggering the MBS specific SDT procedure 1018. In some embodiments, the multicast specific SDT request 1014 may include an indication of a multicast session identifier (ID) that the UE 1002 is expected to receive.

The network element 1004 may detect the multicast specific SDT request 1014 received from the UE 1002. Based on the multicast specific SDT request 1014, the network element 1004 may determine that the UE 1002 is available for multicast data reception. In instances where the multicast specific SDT request 1014 includes the multicast session ID, the network element 1004 may determine to provide multicast data associated with the multicast session ID. The network element 1004 may transmit multicast data 1016 to the UE 1002 via DTCH. The multicast data 1016 may be configured in accordance with the multicast specific SDT configuration.

The UE 1002 may receive and process the multicast data 1016 during the SDT procedure 1018. The UE may receive the multicast data 1016 over the DTCH. The UE 1002 may process the multicast data 1016 in accordance with the multicast specific SDT configuration provided in the RRCRelease with SuspendCfg message 1008.

The network element 1004 may deactivate the MBS session after the multicast data 1016 has been transmitted. The network element 1004 may transmit an RRCRelease with SuspendCfg message 1020 to the UE 1002 to deactivate the MBS session. The RRCRelease with SuspendCfg message 1020 may indicate to the UE 1002 that the SDT procedure 1018 is to be terminated.

The UE 1002 may detect the RRCRelease with SuspendCfg message 1020 received from the network element 1004. The UE 1002 may stop receiving multicast data via the DTCH and end the SDT procedure 1018 based on the RRCRelease with SuspendCfg message 1020.

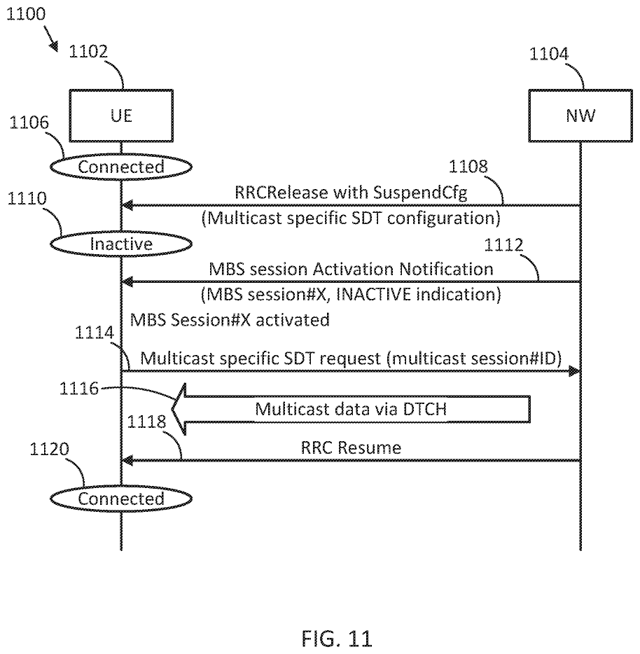

FIG. 11 illustrates another example SDT procedure signaling chart 1100 in accordance with some embodiments. The SDT procedure signaling chart 1100 illustrates example signaling that may be performed related to an SDT procedure. In the illustrated embodiment, the NW may determine that a UE is to be transitioned into a connected state based on data to be exchanged with the UE.

The signaling chart 1100 illustrates transmissions between a UE 1102 and a network element 1104 that may be transmitted related an SDT procedure in accordance with some embodiments. The UE 1102 may include one or more of the features of the UE 1800 (FIG. 18). The network element 1104 may include one or more of the features of the gNB 1900 (FIG. 19). The UE 1102 may be in a connected state at the beginning of the signaling chart 1100, as indicated by connected 1106. The UE 1102 may maintain a connection (such as an RRC connection) with the network element 1104 when the UE 1102 is in the connected state.

The network element 1104 may transmit an RRCRelease with SuspendCfg message 1108 to the UE 1102 while the UE 1102 is in the connected state. The RRCRelease with SuspendCfg message 1108 may indicate that the UE 1102 is to transition to an inactive state. The RRCRelease with SuspendCfg message 1108 may indicate a multicast specific SDT configuration. The multicast specific SDT configuration may indicate a configuration for multicast transmissions exchanged during an SDT procedure between the UE 1102 and the network element 1104. In some embodiments, the RRCRelease with SuspendCfg message 1108 may indicate whether the UE 1102 is to implement the MBS specific SDT RACH procedure, the MBS specific resume cause value approach, and/or the MBS activation specific L2 and/or L1 information approach.

The UE 1102 may detect the RRCRelease with SuspendCfg message 1108 received from the network element 1104. The UE 1102 may store the multicast specific SDT configuration in a memory of the UE 1102. The UE 1102 may be configured with the multicast specific SDT configuration for receiving multicast data during an SDT procedure in response to detecting the RRCRelease with SuspendCfg message 1108. The UE 1102 may further determine that the UE 1102 is to transition to the inactive state based on the RRCRelease with SuspendCfg message 1108. Accordingly, the UE 1102 may transition to the inactive state based on the RRCRelease with SuspendCfg message 1108, as indicated by inactive 1110.

The network element 1104 may transmit an MBS session activation notification message 1112 to the UE 1102 while the UE 1102 is in the inactive state. The MBS session activation notification message 1112 may be a special, specific paging message from the NW side. The MBS session activation notification message 1112 may include an indication of which MBS session is being activated in accordance with the MBS session activation notification message 1112. For example, the MBS session activation notification message 1112 may indicate that MBS session #X is being activated in the illustrated embodiment. In some embodiments, the MBS session activation notification message 1112 may further indicate a preferred state for the UE 1102 for reception of the multicast data. In the illustrated embodiment, the MBS session activation notification message 1112 indicates that the inactive state is preferred for the UE 1102 to receive the multicast data. Accordingly, the MBS session activation notification message 1112 may indicate a preference for the UE 1102 to remain in the inactive state to receive the activated MBS session #X in the illustrated.

The UE 1102 may detect the MBS session activation notification message 1112 received from the network element 1104. Based on the detection of the MBS session activation notification message 1112, the UE 1102 may activate the MBS session #X. Further, the UE 1102 may trigger an MBS specific SDT procedure for receipt of multicast data based on the MBS session activation notification message 1112. The UE may transmit a multicast specific SDT request 1114 to the network element 1104 as part of triggering the MBS specific SDT procedure. In some embodiments, the multicast specific SDT request 1114 may include an indication of a multicast session identifier (ID) that the UE 1102 is expected to receive.

The network element 1104 may detect the multicast specific SDT request 1114 received from the UE 1102. Based on the multicast specific SDT request 1114, the network element 1104 may determine that the UE 1102 is available for multicast data reception. In instances where the multicast specific SDT request 1114 includes the multicast session ID, the network element 1104 may determine to provide multicast data associated with the multicast session ID. The network element 1104 may transmit multicast data 1116 to the UE 1102 via DTCH. The multicast data 1116 may be configured in accordance with the multicast specific SDT configuration.

The UE 1102 may receive and process the multicast data 1116 during the SDT procedure. The UE may receive the multicast data 1116 over the DTCH. The UE 1102 may process the multicast data 1116 in accordance with the multicast specific SDT configuration provided in the RRCRelease with SuspendCfg message 1108.

The network element 1104 may determine that the UE 1102 is to be transitioned back to the connected state. The network element 1104 may determine that the UE 1102 is to be transitioned back to the connected state based on the data to be transmitted to the UE 1102 and/or data to be received from the UE 1102. For example, the network element 1104 may determine that the UE 1102 is to be transitioned back to the connected state based on an amount of data to be transmitted to the UE 1102 being greater than a threshold amount and/or going to take longer than a threshold time period. In other instances, the network element 1104 may determine that the UE 1102 is to be transitioned back to the connected state based on a determination that data is to be received from the UE 1102. The network element 1104 may transmit an RRC resume message 1118 to the UE 1102 to indicate to the UE 1102 that the UE 1102 is to transition to the connected state.

The UE 1102 may detect the RRC resume message 1118 received from the network element 1104. Based on the RRC resume message 1118, the UE 1102 may transition to the connected state, as indicated by connected 1120.

### Approach 3: The High-Reliability Scheduling in Inactive State

Approach: UE based link selection scheme based on the condition related to the transmission/radio quality. For example, a UE may determine which link to utilize and/or which state the UE is to be in based on transmission and/or radio quality between the UE and a network element.

The condition may include several options: 1) Radio quality<threshold?; 2) Number of consecutive transport blocks (TBs) received incorrectly>threshold?; 3) L2 reception failure?; 4) PDCP T_reordering is time-out?; and 5) Upper layer indicate the reception error occurred?

Where the condition is based on radio quality, the UE may determine a current radio quality between the UE and the network element. If the UE determines that the current radio quality is equal to or better than a threshold radio quality, the UE may determine that the UE is to utilize a first link and/or be in a first state for receiving data from the network. If the UE determines that the current radio quality is worse than the threshold radio quality, the UE may determine that the UE is to utilize a second link and/or be in a second state for receiving data from the network. The second link may be different from the first link and the second state may be different from the first state.

Where the condition is based on the number of TBs received incorrectly, the UE may monitor how many consecutive TBs are received incorrectly from the network element. If the UE determines that the number of consecutive TBs received incorrectly is equal to or less than a threshold number, the UE may determine that the UE is to utilize a first link and/or be in a first state for receiving data from the network. If the UE determines that the number of consecutive TBs received incorrectly is greater than the threshold number, the UE may determine that the UE is to utilize a second link and/or be in a second state for receiving data from the network. The second link may be different from the first link and the second state may be different from the first state.

Where the condition is based on the L2 reception failure, the UE may determine whether an L2 reception failure has occurred with the network element. If the UE determines that L2 reception failure has not occurred with the network element, the UE may determine that the UE is to utilize a first link and/or be in a first state for receiving data from the network. If the UE determines that an L2 reception failure has occurred with the network element, the UE may determine that the UE is to utilize a second link and/or be in a second state for receiving data from the network. The second link may be different from the first link and the second state may be different from the first state.

Where the condition is based on the PDCP T_reordering timer, the UE may determine whether the PDCP T_reordering timer has timed out. If the UE determines that the PDCP T_reordering timer hasn't timed out, the UE may determine that the UE is to utilize a first link and/or be in a first state for receiving data from the network. If the UE determines that the PDCP T_reordering timer has timed out, the UE may determine that the UE is to utilize a second link and/or be in a second state for receiving data from the network. The second link may be different from the first link and the second state may be different from the first state.

Where the condition is based on the upper layer indication, the UE may determine whether a reception error with the network element has been indicated by an upper layer. If the UE determines that a reception error hasn't been indicated by an upper layer, the UE may determine that the UE is to utilize a first link and/or be in a first state for receiving data from the network. If the UE determines that reception error has been indicated by an upper layer, the UE may determine that the UE is to utilize a second link and/or be in a second state for receiving data from the network. The second link may be different from the first link and the second state may be different from the first state.

Option 1: UE can based on link quality, radio quality, or the transmission quality to select the MTCH or DTCH reception in INACTIVE state. For example, the UE may determine whether to receive data via the MTCH or the MTCH based on a current link quality, radio quality, and/or a current transmission quality with the network element. If the radio quality is greater than or equal to a threshold, UE can follow broadcast similar mechanism to receive the multicast MBS via MTCH channel (as approach 1). For example, the UE may receive multicast data transmitted by the network element via the MTCH. If the radio quality less than the threshold, UE can trigger the MBS specific SDT procedure to receive the multicast MBS via DTCH channel (as approach 2). For example, the UE may trigger an SDT procedure and receive multicast data via the DTCH.

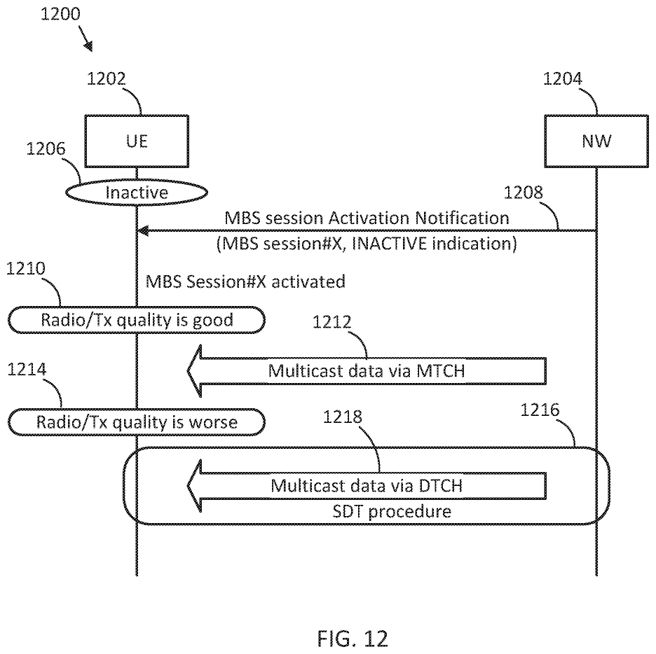

FIG. 12 illustrates an example signaling chart 1200 related to multicast data reception in accordance with some embodiments. The signaling chart 1200 indicates transmissions that may occur for multicast reception by a UE. In particular, the UE may determine a channel on which to receive multicast data based on radio quality and/or transmission quality of the UE with a network element.

The signaling chart 1200 illustrates transmissions between a UE 1202 and a network element 1204 that may be transmitted for multicast data reception in accordance with some embodiments. The UE 1202 may include one or more of the features of the UE 1800 (FIG. 18). The network element 1204 may include one or more of the features of the gNB 1900 (FIG. 19). The UE 1202 may be in an inactive state at the beginning of the signaling chart 1200, as indicated by inactive 1206.

The network element 1204 may transmit an MBS session activation notification message 1208 to the UE 1202 while the UE 1202 is in the inactive state. The MBS session activation notification message 1208 may be a special, specific paging message from the NW side. The MBS session activation notification message 1208 may include an indication of which MBS session is being activated in accordance with the MBS session activation notification message 1208. For example, the MBS session activation notification message 1208 may indicate that MBS session #X is being activated in the illustrated embodiment. In some embodiments, the MBS session activation notification message 1208 may further indicate a preferred state for the UE 1202 for reception of the multicast data. In the illustrated embodiment, the MBS session activation notification message 1208 indicates that the inactive state is preferred for the UE 1202 to receive the multicast data. Accordingly, the MBS session activation notification message 1208 may indicate a preference for the UE 1202 to remain in the inactive state to receive the activated MBS session #X in the illustrated.

The UE 1202 may detect the MBS session activation notification message 1208 received from the network element 1204. Based on the detection of the MBS session activation notification message 1208, the UE 1202 may activate the MBS session #X.

The UE 1202 may determine a radio quality and/or transmission quality of the UE 1202 with the network element 1204 as the MBS session #X is activated. In the illustrated embodiment, the UE 1202 may determine that the radio quality and/or transmission quality of the UE 1202 with the network element 1204 is good, as indicated by 1210. The UE 1202 may determine that the radio quality and/or the transmission quality is good based on the radio quality and/or the transmission quality is equal to or better than a threshold quality. Based on the UE 1202 determining that the radio quality and/or transmission quality is good, the UE 1202 may determine to receive the multicast data via the MTCH (which may be a first link) in the illustrated embodiment. In some embodiments, the UE 1202 may indicate to the network element 1204 that the multicast data is to be transmitted via the MTCH.

The network element 1204 may transmit multicast data 1212 to the UE 1202 via the MTCH. In embodiments where the UE 1202 indicates that the multicast data is to be transmitted via the MTCH, the network element 1204 may transmit the multicast data 1212 via the MTCH based on the indication. The UE 1202 may receive and process the multicast data 1212 via the MTCH.

The UE 1202 may determine that the radio quality and/or the transmission quality of the UE 1202 is bad, as indicated by 1214. The UE 1202 may determine that the radio quality and/or the transmission quality of the UE 1202 is bad based on the radio quality and/or the transmission quality being worse than the threshold quality. Based on the UE 1202 determining that the radio quality and/or the transmission is bad, the UE 1202 may determine to receive the multicast data via the DTCH (which may be a second link) in the illustrated embodiment. In some embodiments, the UE 1202 may indicate to the network element 1204 that the multicast data is to be transmitted via the DTCH. The UE 1202 may initiate an SDT procedure 1216 for receiving the multicast data via the DTCH. The SDT procedure 1216 may be initiated and/or include one or more of the features of the SDT procedure 1018 (FIG. 10).

The network element 1204 may transmit multicast data 1218 via the DTCH. The network element 1204 may transmit the multicast data 1218 via the DTCH based on the indication from the UE 1202 and/or the SDT procedure 1216. The UE 1202 may receive and process the multicast data 1218 via the DTCH.

Option 2: UE can trigger the RRCResume if the current radio quality/transmission quality is not good. For example, the UE can trigger an RRC resume procedure that causes the UE to transition to the connected state based on a determination that a current radio quality and/or the transmission quality is not good. The UE may determine that the current radio quality and/or the transmission quality is not good based on the current radio quality and/or the transmission quality being worse than a threshold quality. The UE can trigger the RRCResume and enter the CONNECTED state when the condition is fulfilled. For example, the UE may trigger the RRC resume procedure based on one or more of the conditions for the UE based link selection scheme described above being fulfilled. In particular, the conditions may be fulfilled on the radio quality being worse than the threshold quality, the number of consecutive TBs received incorrectly being greater than the threshold number, an L2 reception failure being detected, the PDCP T_reordering timer timing out, and/or the upper layer indicating that a reception error occurred.

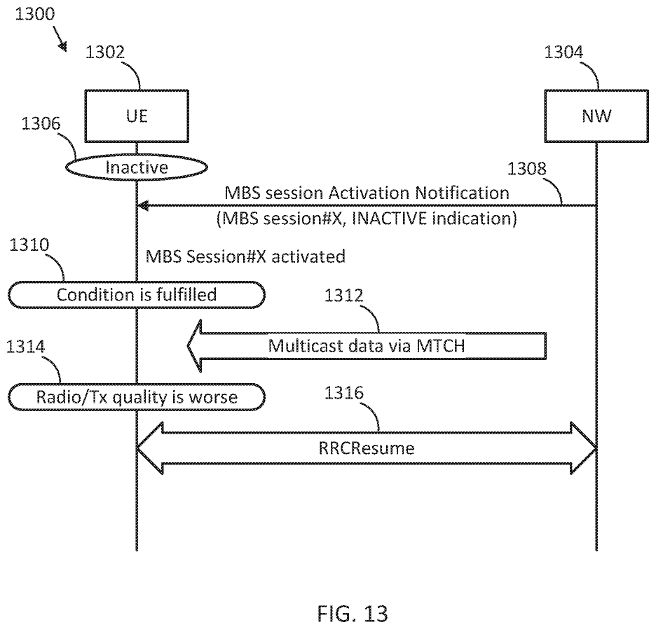

FIG. 13 illustrates an example signaling chart 1300 related to multicast data reception in accordance with some embodiments. The signaling chart 1300 indicates transmissions that may occur for multicast reception by a UE. In particular, the UE may determine a state in which the UE is to be to receive multicast data based on radio quality and/or transmission quality of the UE with a network element.

The signaling chart 1300 illustrates transmissions between a UE 1302 and a network element 1304 that may be transmitted for multicast data reception in accordance with some embodiments. The UE 1302 may include one or more of the features of the UE 1800 (FIG. 18). The network element 1304 may include one or more of the features of the gNB 1900 (FIG. 19). The UE 1302 may be in an inactive state at the beginning of the signaling chart 1300, as indicated by inactive 1306.

The network element 1304 may transmit an MBS session activation notification message 1308 to the UE 1302 while the UE 1302 is in the inactive state. The MBS session activation notification message 1308 may be a special, specific paging message from the NW side. The MBS session activation notification message 1308 may include an indication of which MBS session is being activated in accordance with the MBS session activation notification message 1308. For example, the MBS session activation notification message 1308 may indicate that MBS session #X is being activated in the illustrated embodiment. In some embodiments, the MBS session activation notification message 1308 may further indicate a preferred state for the UE 1302 for reception of the multicast data. In the illustrated embodiment, the MBS session activation notification message 1308 indicates that the inactive state is preferred for the UE 1302 to receive the multicast data. Accordingly, the MBS session activation notification message 1308 may indicate a preference for the UE 1302 to remain in the inactive state to receive the activated MBS session #X in the illustrated.

The UE 1302 may detect the MBS session activation notification message 1308 received from the network element 1304. Based on the detection of the MBS session activation notification message 1308, the UE 1302 may activate the MBS session #X.

The UE 1302 may determine a radio quality and/or transmission quality of the UE 1302 with the network element 1304 as the MBS session #X is activated. In the illustrated embodiment, the UE 1302 may determine that the radio quality and/or transmission quality of the UE 1302 with the network element 1304 is good, as indicated by 1310. The UE 1302 may determine that the radio quality and/or the transmission quality is good based on the radio quality and/or the transmission quality is equal to or better than a threshold quality. Based on the UE 1302 determining that the radio quality and/or transmission quality is good, the UE 1302 may determine to receive the multicast data via the MTCH (which may be a first link) in the illustrated embodiment. In some embodiments, the UE 1302 may indicate to the network element 1304 that the multicast data is to be transmitted via the MTCH.

The network element 1304 may transmit multicast data 1312 to the UE 1302 via the MTCH. In embodiments where the UE 1302 indicates that the multicast data is to be transmitted via the MTCH, the network element 1304 may transmit the multicast data 1312 via the MTCH based on the indication. The UE 1302 may receive and process the multicast data 1312 via the MTCH.

The UE 1302 may determine that the radio quality and/or the transmission quality of the UE 1302 is bad, as indicated by 1314. The UE 1302 may determine that the radio quality and/or the transmission quality of the UE 1302 is bad based on the radio quality and/or the transmission quality being worse than the threshold quality. Based on the UE 1302 determining that the radio quality and/or the transmission is bad, the UE 1302 may determine to initiate an RRC resume procedure 1316. The UE 1302 may utilize the RRC resume procedure 1316 to transition to a connected state with the network element 1304. The UE 1302 and the network element 1304 may exchange data via the connection established via the RRC resume procedure 1316.

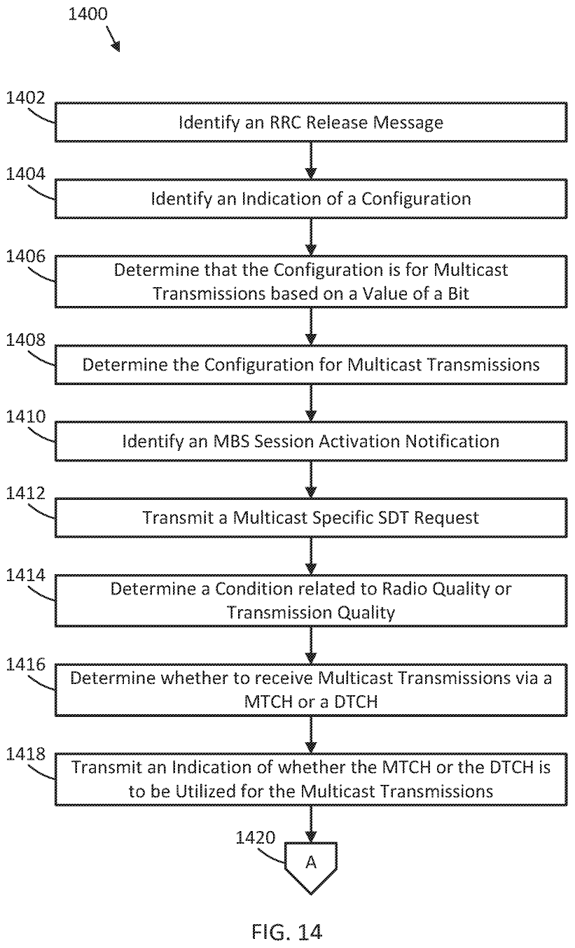

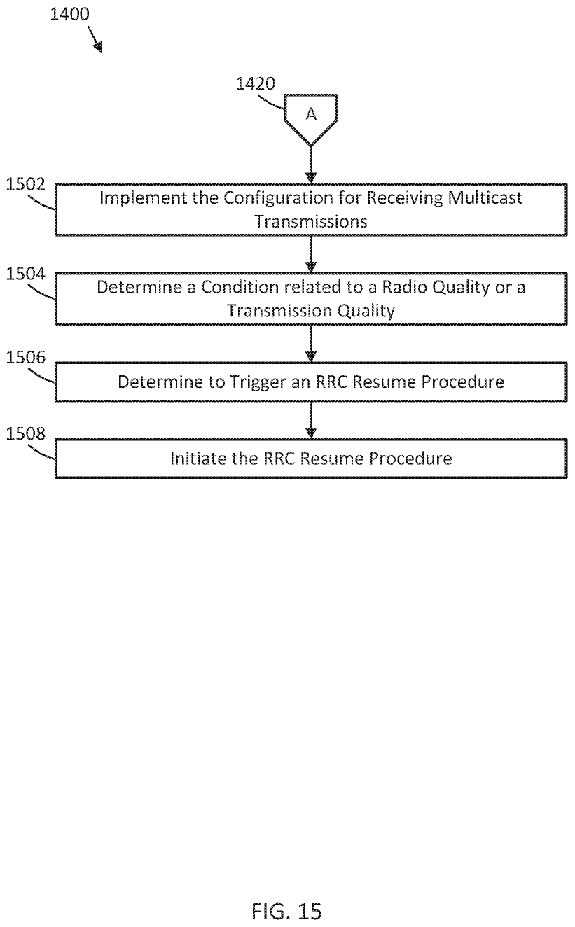

FIG. 14 illustrates a first portion of an example procedure 1400 related to multicast transmissions received by a UE while in the inactive state in accordance with some embodiments. FIG. 15 illustrates a second portion of the example procedure 1400 of FIG. 14 in accordance with some embodiments. The procedure 1400 may be performed by a UE (such as the UE 402 (FIG. 4), the UE 502 (FIG. 5), the UE 602 (FIG. 6), the UE 1002 (FIG. 10), the UE 1102 (FIG. 11), the UE 1202 (FIG. 12), the UE 1302 (FIG. 13) and/or the UE 1800 (FIG. 18)).

The procedure 1400 may include identifying an RRC release message in 1402. In particular, the UE may identify an RRC release message that includes an indication of a configuration. The configuration may comprise a multicast SDT configuration. In some embodiments, 1402 may be omitted.

The procedure 1400 may include identifying an indication of a configuration in 1404. In particular, the UE may identify an indication of a configuration received from a base station. The configuration may be for multicast transmissions received by the UE while in an inactive state. In embodiments where 1402 is included, the UE may identify the configuration in the RRC release message. In some embodiments, the configuration may comprise an MCCH configuration for multicast transmissions. Further, the configuration may indicate one or more MBS sessions and MTCH configurations for multicast MBS in some embodiments. In some embodiments, the indication of the configuration may indicate both multicast and broadcast MBS multicast traffic channel configuration. Further, the indication of the configuration may be received via dedicated RRC signaling in some embodiments.

The procedure 1400 may include determining that the configuration is for multicast transmissions based on a value of a bit in 1406. For example, the indication of the configuration identified in 1404 may include a bit. The UE may determine that the configuration is for multicast transmissions based on a value of the bit. In some embodiments, 1406 may be omitted.

The procedure 1400 may include determining the configuration for multicast transmissions in 1408. In particular, the UE may determine the configuration for multicast transmission received by the UE while in the inactive state based on the indication identified in 1404.

The procedure 1400 may include identifying an MBS session activation notification in 1410. In particular, the UE may identify an MBS session activation notification received from the base station. In some embodiments, 1410 may be omitted.

The procedure 1400 may include transmitting a multicast specific SDT request in 1412. In particular, the UE may transmit a multicast specific SDT request based on the MBS session activation notification identified in 1410. In some embodiments, the multicast specific SDT request indicates an MBS specific SDT RACH procedure, an MBS specific resume cause value, or MBS activation specific layer 2 or layer 1 information. In some embodiments, 1412 may be omitted.

The procedure 1400 may include determining a condition related to radio quality or transmission quality in 1414. In particular, the UE may determine a condition related to radio quality or transmission quality associated with the UE. In some embodiments, 1414 may be omitted.

The procedure 1400 may include determining whether to receive multicast transmissions via a MTCH or a DTCH in 1416. In particular, the UE may determine whether to received multicast transmissions received while the UE is in the inactive state via a MTCH or a DTCH based on the condition determined in 1414. In some embodiments, 1416 may be omitted.

The procedure 1400 may include transmitting an indication of whether the MTCH or the DTCH is to be utilized for the multicast transmissions in 1418. In particular, the UE may transmit an indication of whether the MTCH or the DTCH is to be utilized for the multicast transmissions received while the UE is in the inactive state based on the determination whether to receive the multicast transmissions received while the UE is in the inactive state via the MTCH or the DTCH in 1416. In some embodiments, 1418 may be omitted.

The procedure 1400 may proceed from 1418 to reference 1420. Reference 1420 indicates that the procedure 1400 may proceed from 1418 in FIG. 14 to 1502 in FIG. 15.

The procedure 1400 may include implementing the configuration for receiving multicast transmissions in 1502. In particular, the UE may implement the configuration for receiving multicast transmissions received by the UE while in the inactive state. In some embodiments, to implement the configuration includes to support PTM transmission without feedback.

The procedure 1400 may include determining a condition related to a radio quality or transmission quality in 1504. In particular, the UE may determine a condition related to a radio quality or a transmission quality associated with the UE. In some embodiments, 1504 may be omitted.

The procedure 1400 may include determining to trigger an RRC resume procedure in 1506. In particular, the UE may determine to trigger an RRC resume procedure based on the condition determined in 1504. In some embodiments, 1506 may be omitted.

The procedure 1400 may include initiating the RRC resume procedure in 1508. In particular, the UE may initiate the RRC resume procedure based on the determination to trigger the RRC resume procedure. In some embodiments, 1508 may be omitted.

While FIG. 14 and FIG. 15 illustrate operations that may be performed during the procedure 1400, it should be understood that one or more of the operations may be omitted and/or one or more other operations may be added in other embodiments. Further, while FIG. 14 and FIG. 15 may imply an order of the operations in the procedure 1400, it should be understood that the operations may be performed in a different order and/or one or more of the operations may be performed concurrently in other embodiments.

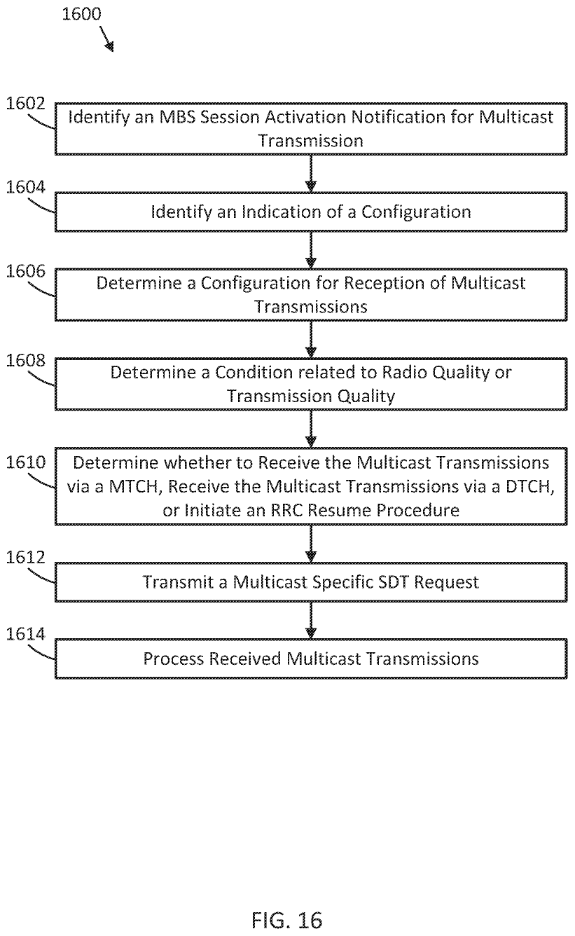

FIG. 16 illustrates an example procedure 1600 related to multicast transmissions in accordance with some embodiments. The procedure 1600 may be performed by a UE (such as the UE 402 (FIG. 4), the UE 502 (FIG. 5), the UE 602 (FIG. 6), the UE 1002 (FIG. 10), the UE 1102 (FIG. 11), the UE 1202 (FIG. 12), the UE 1302 (FIG. 13) and/or the UE 1800 (FIG. 18)).

The procedure 1600 may include identifying an MBS session activation notification for multicast transmission in 1602. In particular, the UE may identify an MBS session activation notification for multicast transmission received from a base station during an inactive state of the UE.

The procedure 1600 may include identifying an indication of a configuration in 1604. In particular, the UE may identify an indication of a configuration. In some embodiments, the indication may include a bit that indicates that the configuration is for multicast transmissions. In some embodiments, the UE may identify an indication of the configuration received in an RRC release message received from the based station. In these embodiments, the configuration may comprise a multicast specific SDT configuration. In some embodiments, 1604 may be omitted.

The procedure 1600 may include determining a configuration for reception of multicast transmissions in 1606. In particular, the UE may determine a configuration for reception of multicast transmissions based on the MBS session activation notification identified in 1602. In embodiments where 1604 is included, the configuration determined for reception may be the configuration from the indication of the configuration identified in 1604. In some embodiments, the configuration indications one or more MBS sessions and MTCH configuration for multicast MBS.

The procedure 1600 may include determining a condition related to radio quality or transmission quality in 1608. In particular, the UE may determine a condition related to radio quality or transmission quality associated with the UE. In some embodiments, 1608 may be omitted.

The procedure 1600 may include determining whether to receive the multicast transmissions via a MTCH, receive the multicast transmissions via a DTCH, or initiate an RRC resume procedure in 1610. In particular, the UE may determine whether to receive the multicast transmissions via a MTCH, receive the multicast transmissions via a DTCH, or initiate an RRC resume procedure based on the condition. In some embodiments, 1610 may be omitted.

The procedure 1600 may include transmitting a multicast specific SDT request in 1612. In particular, the UE may transmit a multicast specific SDT request to the base station based on the MBS session activation notification for multicast transmission.

The procedure 1600 may include processing received multicast transmissions in 1614. In particular, the UE may process received multicast transmissions in accordance with the determined configuration from 1606.

While FIG. 16 illustrates operations that may be performed during the procedure 1600, it should be understood that one or more of the operations may be omitted and/or one or more other operations may be added in other embodiments. Further, while FIG. 16 may imply an order of the operations in the procedure 1600, it should be understood that the operations may be performed in a different order and/or one or more of the operations may be performed concurrently in other embodiments.

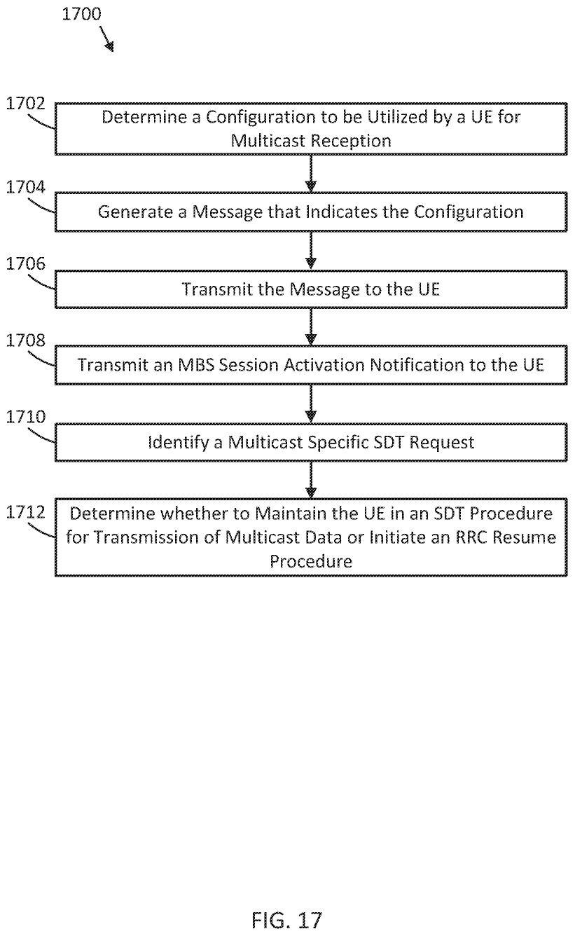

FIG. 17 illustrates an example procedure 1700 related to multicast transmissions in accordance with some embodiments. The procedure 1700 may be performed by a network element (such as the network element 404 (FIG. 4), the network element 504 (FIG. 5), the network element 604 (FIG. 6), the network element 1004 (FIG. 10), the network element 1104 (FIG. 11), the network element 1204 (FIG. 12), the network element 1304 (FIG. 13), and/or the gNB 1900 (FIG. 19)). The procedure 1700 is described as being performed by a base station herein, although it is to be understood that other network elements may perform the procedure 1700.

The procedure 1700 may include determining a configuration to be utilized by a UE for multicast reception in 1702. In particular, the base station may include determining a configuration to be utilized by a UE for multicast reception during an inactive state of the UE. In some embodiments, the configuration may indicate MBS sessions and MTCH configurations for multicast MBS. Further, the configuration may comprise a multicast specific SDT configuration in some embodiments.

The procedure 1700 may include generating a message that indicates the configuration. For example, the base station may generate a message that indicates the configuration to be utilized by the UE. In some embodiments, the message may include a bit that indicates that the configuration is to be utilized by the UE for multicast reception during the inactive state of the UE.

The procedure 1700 may include transmitting the message to the UE in 1706. For example, the base station may transmit the message to the UE to indicate the configuration. In some embodiments, transmitting the message may comprise transmitting an RRC release message.

The procedure 1700 may include transmitting an MBS session activation notification to the UE in 1708. For example, the base station may transmit an MBS session activation notification to the UE. In some embodiments, 1708 may be omitted.

The procedure 1700 may include identifying a multicast specific SDT request in 1710. For example, the base station may identify a multicast specific SDT request received from the UE. In some embodiments, 1710 may be omitted.

The procedure 1700 may include determining whether to maintain the UE in an SDT procedure for transmission of multicast data or initiate an RRC resume procedure in 1712. For example, the base station may determine whether to maintain the UE in an SDT procedure for transmission of multicast data via a DTCH or initiate an RRC resume procedure for the UE based on the multicast specific SDT request. In some embodiments, 1712 may be omitted.

FIG. 18 illustrates an example UE 1800 in accordance with some embodiments. The UE 1800 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the UE 1800 may be a RedCap UE or NR-Light UE.

The UE 1800 may include processors 1804, RF interface circuitry 1808, memory/storage 1812, user interface 1816, sensors 1820, driver circuitry 1822, power management integrated circuit (PMIC) 1824, antenna structure 1826, and battery 1828. The components of the UE 1800 may be implemented as integrated circuits (ICs), portions thereof, discrete electronic devices, or other modules, logic, hardware, software, firmware, or a combination thereof. The block diagram of FIG. 18 is intended to show a high-level view of some of the components of the UE 1800. However, some of the components shown may be omitted, additional components may be present, and different arrangement of the components shown may occur in other implementations.

The components of the UE 1800 may be coupled with various other components over one or more interconnects 1832, which may represent any type of interface, input/output, bus (local, system, or expansion), transmission line, trace, optical connection, etc. that allows various circuit components (on common or different chips or chipsets) to interact with one another.

The processors 1804 may include processor circuitry such as, for example, baseband processor circuitry (BB) 1804A, central processor unit circuitry (CPU) 1804B, and graphics processor unit circuitry (GPU) 1804C. The processors 1804 may include any type of circuitry or processor circuitry that executes or otherwise operates computer-executable instructions, such as program code, software modules, or functional processes from memory/storage 1812 to cause the UE 1800 to perform operations as described herein.

In some embodiments, the baseband processor circuitry 1804A may access a communication protocol stack 1836 in the memory/storage 1812 to communicate over a 3GPP compatible network. In general, the baseband processor circuitry 1804A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1808.

The baseband processor circuitry 1804A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1812 may include one or more non-transitory, computer-readable media that includes instructions (for example, communication protocol stack 1836) that may be executed by one or more of the processors 1804 to cause the UE 1800 to perform various operations described herein. The memory/storage 1812 include any type of volatile or non-volatile memory that may be distributed throughout the UE 1800. In some embodiments, some of the memory/storage 1812 may be located on the processors 1804 themselves (for example, L1 and L2 cache), while other memory/storage 1812 is external to the processors 1804 but accessible thereto via a memory interface. The memory/storage 1812 may include any suitable volatile or non-volatile memory such as, but not limited to, dynamic random access memory (DRAM), static random access memory (SRAM), eraseable programmable read only memory (EPROM), electrically eraseable programmable read only memory (EEPROM), Flash memory, solid-state memory, or any other type of memory device technology.

The RF interface circuitry 1808 may include transceiver circuitry and radio frequency front module (RFEM) that allows the UE 1800 to communicate with other devices over a radio access network. The RF interface circuitry 1808 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1826 and proceed to filter and amplify (with a low-noise amplifier) the signal. The signal may be provided to a receiver of the transceiver that down-converts the RF signal into a baseband signal that is provided to the baseband processor of the processors 1804.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1826.

In various embodiments, the RF interface circuitry 1808 may be configured to transmit/receive signals in a manner compatible with NR access technologies.

The antenna 1826 may include antenna elements to convert electrical signals into radio waves to travel through the air and to convert received radio waves into electrical signals. The antenna elements may be arranged into one or more antenna panels. The antenna 1826 may have antenna panels that are omnidirectional, directional, or a combination thereof to enable beamforming and multiple input, multiple output communications. The antenna 1826 may include microstrip antennas, printed antennas fabricated on the surface of one or more printed circuit boards, patch antennas, phased array antennas, etc. The antenna 1826 may have one or more panels designed for specific frequency bands including bands in FR1 or FR2.

The user interface circuitry 1816 includes various input/output (I/O) devices designed to enable user interaction with the UE 1800. The user interface 1816 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1800.

The sensors 1820 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1822 may include software and hardware elements that operate to control particular devices that are embedded in the UE 1800, attached to the UE 1800, or otherwise communicatively coupled with the UE 1800. The driver circuitry 1822 may include individual drivers allowing other components to interact with or control various input/output (I/O) devices that may be present within, or connected to, the UE 1800. For example, driver circuitry 1822 may include a display driver to control and allow access to a display device, a touchscreen driver to control and allow access to a touchscreen interface, sensor drivers to obtain sensor readings of sensor circuitry 1820 and control and allow access to sensor circuitry 1820, drivers to obtain actuator positions of electro-mechanic components or control and allow access to the electro-mechanic components, a camera driver to control and allow access to an embedded image capture device, audio drivers to control and allow access to one or more audio devices.

The PMIC 1824 may manage power provided to various components of the UE 1800. In particular, with respect to the processors 1804, the PMIC 1824 may control power-source selection, voltage scaling, battery charging, or DC-to-DC conversion.

In some embodiments, the PMIC 1824 may control, or otherwise be part of, various power saving mechanisms of the UE 1800. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1800 may power down for brief intervals of time and thus save power. If there is no data traffic activity for an extended period of time, then the UE 1800 may transition off to an RRC_Idle state, where it disconnects from the network and does not perform operations such as channel quality feedback, handover, etc. The UE 1800 goes into a very low power state and it performs paging where again it periodically wakes up to listen to the network and then powers down again. The UE 1800 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1828 may power the UE 1800, although in some examples the UE 1800 may be mounted deployed in a fixed location, and may have a power supply coupled to an electrical grid. The battery 1828 may be a lithium ion battery, a metal-air battery, such as a zinc-air battery, an aluminum-air battery, a lithium-air battery, and the like. In some implementations, such as in vehicle-based applications, the battery 1828 may be a typical lead-acid automotive battery.

FIG. 19 illustrates an example gNB 1900 in accordance with some embodiments. The gNB 1900 may include processors 1904, RF interface circuitry 1908, core network (CN) interface circuitry 1912, memory/storage circuitry 1916, and antenna structure 1926.

The components of the gNB 1900 may be coupled with various other components over one or more interconnects 1928.

The processors 1904, RF interface circuitry 1908, memory/storage circuitry 1916 (including communication protocol stack 1910), antenna structure 1926, and interconnects 1928 may be similar to like-named elements shown and described with respect to FIG. 18.

The CN interface circuitry 1912 may provide connectivity to a core network, for example, a 5th Generation Core network (5GC) using a 5GC-compatible network interface protocol such as carrier Ethernet protocols, or some other suitable protocol. Network connectivity may be provided to/from the gNB 1900 via a fiber optic or wireless backhaul. The CN interface circuitry 1912 may include one or more dedicated processors or FPGAs to communicate using one or more of the aforementioned protocols. In some implementations, the CN interface circuitry 1912 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method comprising identifying an indication of a configuration received from a base station, the configuration for multicast transmissions received by the UE while in an inactive state, determining the configuration for multicast transmissions received by the UE when in the inactive state based on the indication, and implementing the configuration for receiving multicast transmissions received by the UE while in the inactive state.

Example 2 may include the method of example 1, wherein the indication of the configuration comprises a bit, and wherein the method further comprises determining that the configuration is for multicast transmissions based on a value of the bit.

Example 3 may include the method of example 1, wherein the configuration comprises a multimedia broadcast multicast service point-to-multipoint control channel (MCCH) configuration for multicast transmissions.

Example 4 may include the method of example 1, wherein the configuration indicates one or more multicast/broadcast service (MBS) sessions and multicast traffic channel (MTCH) configurations for multicast MBS.

Example 5 may include the method of example 1, wherein the indication of the configuration indicates both multicast and broadcast multicast/broadcast service (MBS) multicast traffic channel configuration.

Example 6 may include the method of example 1, wherein the indication of the configuration is received via dedicated radio resource control (RRC) signaling.

Example 7 may include the method of example 1, wherein implementing the configuration includes supporting point to multipoint (PTM) transmission without feedback.

Example 8 may include the method of example 1, further comprising identifying a radio resource control (RRC) release message that includes the indication of the configuration, wherein the configuration comprises a multicast specific small data transmission (SDT) configuration, identifying a multicast/broadcast service (MBS) session activation notification received from the base station, and transmitting a multicast specific SDT request based on the MBS session activation notification.

Example 9 may include the method of example 8, wherein the multicast specific SDT request indicates an MBS specific SDT random access channel (RACH) procedure, an MBS specific resume cause value, or MBS activation specific layer 2 or layer 1 information.

Example 10 may include the method of example 1, further comprising determining a condition related to radio quality or transmission quality associated with the UE, determining whether to receive multicast transmissions received while the UE is in the inactive state via a multicast transmission channel (MTCH) or a dedicated transmission channel (DTCH) based on the condition, and transmitting an indication of whether the MTCH or the DTCH is to be utilized for the multicast transmissions received while the UE is in the inactive state based on the determination whether to receive the multicast transmissions received while the UE is in the inactive state via the MTCH or the DTCH.

Example 11 may include the method of example 1, wherein the instructions, when executed by the one or more processors, further cause the UE to determine a condition related a radio quality or a transmission quality associated with the UE, determine to trigger a radio resource control (RRC) resume procedure based on the condition, and initiate the RRC resume procedure based on the determination to trigger the RRC resume procedure.

Example 12 may include a method of operating a user equipment (UE), comprising identifying a multicast/broadcast service (MBS) session activation notification for multicast transmission received from a base station during an inactive state of the UE, determining a configuration for reception of multicast transmissions based on the MBS session activation notification, and processing received multicast transmissions in accordance with the determined configuration.

Example 13 may include the method of example 12, further comprising identifying an indication of the configuration, wherein the indication comprises a bit that indicates that the configuration is for multicast transmissions.

Example 14 may include the method of example 12, wherein the configuration indicates one or more MBS sessions and multicast traffic channel (MTCH) configurations for multicast MBS.

Example 15 may include the method of example 12, further comprising identifying an indication of the configuration received in a radio resource control (RRC) release message received from the base station, wherein the configuration comprises a multicast specific small data transmission (SDT) configuration, and transmitting a multicast specific SDT request to the base station based on the MBS session activation notification for multicast transmission.

Example 16 may include the method of example 12, further comprising determining a condition related to radio quality or transmission quality associated with the UE, and determining whether to receive the multicast transmissions via a multicast traffic channel (MTCH), receive the multicast transmissions via a dedicated traffic channel (DTCH), or initiate a radio resource control (RRC) resume procedure based on the condition.

Example 17 may include a method of operating a base station, comprising determining a configuration to be utilized by a user equipment (UE) for multicast reception during an inactive state of the UE, generating a message that indicates the configuration to be utilized by the UE, and transmitting the message to the UE to indicate the configuration.

Example 18 may include the method of example 17, wherein the message includes a bit that indicates that the configuration is to be utilized by the UE for multicast reception during the inactive state of the UE.

Example 19 may include the method of example 17, wherein the configuration indicates multicast/broadcast service (MBS) sessions and multicast traffic channel (MTCH) configurations for multicast MBS.

Example 20 may include the method of example 17, wherein the configuration comprises a multicast specific small data transmission (SDT) configuration, wherein transmitting the message comprises transmitting a radio resource control (RRC) release message, and wherein the method further comprises transmitting a multicast/broadcast service (MBS) session activation notification to the UE, identify a multicast specific SDT request received from the UE, and determine whether to maintain the UE in an SDT procedure for transmission of multicast data via a dedicated traffic channel (DTCH) or initiate an RRC resume procedure for the UE based on the multicast specific SDT request.

Example 21 may include an apparatus comprising means to perform one or more elements of a method described in or related to any of examples 1-20, or any other method or process described herein.

Example 22 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 23 may include an apparatus comprising logic, modules, or circuitry to perform one or more elements of a method described in or related to any of examples 1-20, or any other method or process described herein.

Example 24 may include a method, technique, or process as described in or related to any of examples 1-20, or portions or parts thereof.

Example 25 may include an apparatus comprising: one or more processors and one or more computer-readable media comprising instructions that, when executed by the one or more processors, cause the one or more processors to perform the method, techniques, or process as described in or related to any of examples 1-20, or portions thereof.

Example 26 may include a signal as described in or related to any of examples 1-20, or portions or parts thereof.

Example 27 may include a datagram, information element, packet, frame, segment, PDU, or message as described in or related to any of examples 1-20, or portions or parts thereof, or otherwise described in the present disclosure.

Example 28 may include a signal encoded with data as described in or related to any of examples 1-20, or portions or parts thereof, or otherwise described in the present disclosure.

Example 29 may include a signal encoded with a datagram, IE, packet, frame, segment, PDU, or message as described in or related to any of examples 1-20, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Example 31 may include a computer program comprising instructions, wherein execution of the program by a processing element is to cause the processing element to carry out the method, techniques, or process as described in or related to any of examples 1-20, or portions thereof.

Example 32 may include a signal in a wireless network as shown and described herein.

Example 33 may include a method of communicating in a wireless network as shown and described herein.

Example 34 may include a system for providing wireless communication as shown and described herein.

Example 35 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1.-20. (canceled)

21. One or more non-transitory, computer-readable media having instructions that, when executed, cause processing circuitry to:
identify multicast multicast/broadcast service control channel (MCCH) information received from a base station, the multicast MCCH information for multicast transmissions received while in an inactive state; and
utilize the multicast MCCH information for receiving multicast transmissions while in the inactive state.

22. The one or more non-transitory, computer-readable media of claim 21, wherein the multicast MCCH information includes a multicast/broadcast (MBS) multicast configuration message.

23. The one or more non-transitory, computer-readable media of claim 21, wherein the MCCH information is received via an MCCH.

24. The one or more non-transitory, computer-readable media of claim 21, further comprising:
identify a system information block (SIB) received in a message, the SIB including information for configuration for reception of the multicast MCCH information.

25. The one or more non-transitory, computer-readable media of claim 21, wherein the multicast MCCH information is received via radio resource control (RRC) signaling.

26. The one or more non-transitory, computer-readable media of claim 21, wherein the multicast MCCH information is received in a radio resource control (RRC) release message.

27. The one or more non-transitory, computer-readable media of claim 21, further comprising:
identify that a radio quality or a transmission quality is worse than a threshold; and
initiate a radio resource control (RRC) resume procedure based at least in part on the identification of the radio quality or the transmission quality being worse than the threshold.

28. The one or more non-transitory, computer-readable media of claim 27, wherein the radio quality or transmission quality being worse than the threshold is identified during a multicast session.

29. A method comprising:
identifying that a radio quality or a transmission quality is worse than a threshold during a multicast session; and
initiating a radio resource control (RRC) resume procedure based at least in part on the identification of the radio quality or the transmission quality being worse than the threshold.

30. The method of claim 29, further comprising:
identifying received multicast multicast/broadcast service control channel (MCCH) information, the multicast MCCH information for configuration for multicast transmissions received while a user equipment (UE) is in an inactive state; and
utilizing the multicast MCCH information for receiving multicast transmissions while the UE is in the inactive state.

31. The method of claim 30, wherein the multicast MCCH information includes a multicast/broadcast (MBS) multicast configuration message.

32. The method of claim 30, wherein the MCCH information is received via an MCCH.

33. The method of claim 30, further comprising:
identifying a system information block (SIB) received in a message, the SIB including information for configuration for reception of the multicast MCCH information.

34. The method of claim 30, wherein the multicast MCCH information is received via radio resource control (RRC) signaling.

35. The method of claim 30, wherein the multicast MCCH information is received in a radio resource control (RRC) release message.

36. An apparatus comprising:
processing circuitry to:
identify multicast multicast/broadcast service control channel (MCCH) information for a user equipment (UE) for multicast transmissions during an inactive state of the UE; and
generate a message for transmission to the UE that includes the multicast MCCH information; and
interface circuitry coupled with the processing circuitry, the interface circuitry to enable communication.

37. The apparatus of claim 36, wherein the message includes a multicast/broadcast (MBS) multicast configuration message.

38. The apparatus of claim 36, wherein the message is to be transmitted via an MCCH.

39. The apparatus of claim 36, wherein the processing circuitry is further to:
generate a system information block (SIB) for transmission to the UE, the SIB including information for configuration for reception of the message.

40. The apparatus of claim 36, wherein the message includes a radio resource control (RRC) release message.
